(19) United States
(12) Patent Application Publication
(10) Pub. No.: US 2026/0128198 A1
(43) Pub. Date: May 7, 2026

(54) MAGNETIC MATERIALS AND METHODS OF MAKING AND USE THEREOF

(71) Applicants: BOARD OF REGENTS, THE UNIVERSITY OF TEXAS SYSTEM, Austin, TX (US); NUtech Ventures, Lincoln, NE (US); Iowa State University Research Foundation, Inc., an Iowa corporation, Ames, IA (US)

(72) Inventors: James R. Chelikowsky, Austin, TX (US); Balamurugan Balasubramanian, Lincoln, NE (US); Cai-Zhuang Wang, Ames, IA (US); David J. Sellmyer, Lincoln, NE (US)

(21) Appl. No.: 18/939,700

(22) Filed: Nov. 7, 2024

Related U.S. Application Data
(60) Provisional application No. 63/597,383, filed on Nov. 9, 2023.

(51) Int. Cl. H01F 1/153; B22D 11/06; C22B 9/16

(52) U.S. Cl. CPC H01F 1/15333; B22D 11/0602; C22B 9/16

(57) ABSTRACT

Disclosed herein are magnetic materials and methods of making and use thereof. For example, disclosed herein are magnetic materials comprising Fe₄CoSi, Fe₄Co₃Si, FeCo₁₂Si₃, FeCo₆Si, or a combination thereof. Also disclosed herein are magnetic materials comprising Fe₁₂Co₄C, Fe₂Co₆C, Fe₄Co₁₂C, Fe₃Co₉C, Fe₂Co₆C, or a combination thereof. Also disclosed herein are methods of making any of the magnetic materials disclosed herein. Also disclosed herein are methods of making a magnetic material comprising Fe₃CoB₂. Also disclosed herein are methods of use of any of the magnetic materials disclosed herein or any of the magnetic materials made by any of the methods disclosed herein. Also disclosed herein are devices or articles of manufacture comprising any of the magnetic materials disclosed herein or any of the magnetic materials made by any of the methods disclosed herein.

### CROSS-REFERENCE TO RELATED APPLICATIONS

This application claims the benefit of priority to U.S. Provisional Application 63/597,383, filed Nov. 9, 2023, which is hereby incorporated herein by reference in its entirety.

### STATEMENT OF GOVERNMENT SUPPORT

This invention was made with government support under Grant Nos. DMR1729202, DMR1729677, and DMR1729288 awarded by the National Science Foundation. The government has certain rights in the invention.

### BACKGROUND

Magnets play a crucial role in contemporary technologies. Currently, the most widely used magnets contain rare earth (RE) elements. An outstanding challenge of notable scientific interest is the discovery and synthesis of new magnetic materials without rare earth elements that meet the performance and cost goals for advanced electromagnetic devices. The magnetic materials and methods discussed herein address these and other needs.

### SUMMARY

In accordance with the purposes of the disclosed compositions and methods as embodied and broadly described herein, the disclosed subject matter relates to magnetic materials and methods of making and use thereof.

For example, disclosed herein are magnetic materials comprising Fe₄CoSi, Fe₄Co₃Si, FeCo₁₂Si₃, FeCo₆Si, or a combination thereof. In some examples, the magnetic material comprises Fe₄CoSi.

Also disclosed herein are magnetic materials comprising Fe₁₂Co₄C, Fe₂Co₆C, Fe₄Co₁₂C, Fe₃Co₉C, Fe₂Co₆C, or a combination thereof.

In some examples, the magnetic material exhibits a magnetic anisotropy (K₁) of 1 MJ/m³ or more.

In some examples, the magnetic material exhibits a saturation magnetic polarization (Jₛ) of 0.75 Tesla (T) or more or 1 T or more.

In some examples, the magnetic material exhibits a Curie temperature of 840 K or more.

In some examples, the magnetic material has a formation energy within 100 meV/atom relative to the ternary convex hull.

In some examples, the magnetic material exhibits a magnetic anisotropy (K₁) of 1 MJ/m³ or more and a saturation magnetic polarization (Jₛ) of 1 T or more. In some examples, the magnetic material exhibits a magnetic anisotropy (K₁) of 1 MJ/m³ or more and a Curie temperature of 840 K or more. In some examples, the magnetic material exhibits a magnetic anisotropy (K₁) of 1 MJ/m³ or more and the magnetic material has a formation energy within 100 meV/atom relative to the ternary convex hull. In some examples, the magnetic material exhibits a saturation magnetic polarization (Jₛ) of 1 T or more and a Curie temperature of 840 K or more. In some examples, the magnetic material exhibits a saturation magnetic polarization (Jₛ) of 1 T or more and the magnetic material has a formation energy within 100 meV/atom relative to the ternary convex hull. In some examples, the magnetic material exhibits a Curie temperature of 840 K or more and the magnetic material has a formation energy within 100 meV/atom relative to the ternary convex hull. In some examples, the magnetic material exhibits a magnetic anisotropy (K₁) of 1 MJ/m³ or more, a saturation magnetic polarization (Jₛ) of 1 T or more, and a Curie temperature of 840 K or more. In some examples, the magnetic material has a magnetic anisotropy (K₁) of 1 MJ/m³ or more, a saturation magnetic polarization (Jₛ) of 1 T or more, and a formation energy within 100 meV/atom relative to the ternary convex hull. In some examples, the magnetic material has a saturation magnetic polarization (Jₛ) of 1 T or more, a Curie temperature of 840 K or more, and a formation energy within 100 meV/atom relative to the ternary convex hull. In some examples, the magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

In some examples, the magnetic material has a high magnetization.

In some examples, the magnetic material has a high magnetocrystalline anisotropy energy.

In some examples, the magnetic material is substantially free of rare earth elements.

In some examples, the magnetic material is dynamically stable.

In some examples, the magnetic material has a uniaxial magnetic anisotropy.

In some examples, the magnetic material comprises nanoscale to mesoscale crystals.

In some examples, the magnetic material is suitable for permanent magnet applications.

In some examples, the magnetic material has a ground state ferromagnetic (FM) configuration.

Also disclosed herein are methods of making any of the magnetic materials disclosed herein. In some examples, the method comprises a nonequilibrium synthesis method. In some examples, the method comprises chemical solution synthesis, sputtering, arc melting, or a combination thereof. In some examples, the method comprises salt-matrix annealing, surfactant-assisted ball milling, or a combination thereof. In some examples, the method comprises high-temperature high-pressure hydro/solvent-thermal synthesis. In some examples, the method comprises rapid quenching from a melt to thereby produce a magnetic materials with equilibrium or metastable structures. In some examples, the method comprises: combining appropriate amount of high-purity elements to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to rapidly cool the re-melted preliminary alloy to thereby form the magnetic material.

Also disclosed herein are methods of making a magnetic material comprising Fe₃CoB₂, the methods comprising: combining appropriate amount of high-purity Fe, Co, and B to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to cool the re-melted preliminary alloy at a cooling rate of from 1×10⁴ to 1×10⁸ K/s, from 1×10⁵ to 1×10⁸ K/s, or from 1×10⁴ to 1×10⁶ K/s to thereby form the Fe₃CoB₂ magnetic material; wherein the water-cooled rotating wheel is rotated at a rate of from 20-40 m/s. In some examples, rapid quenching from the re-melted preliminary alloy thereby produces the Fe₃CoB₂ magnetic material with equilibrium or metastable structures. In some examples, the method comprises a nonequilibrium synthesis method.

In some examples, the Fe₃CoB₂ magnetic material has an X-ray diffraction pattern comprising characteristic peaks, in terms of plus or minus 0.05 degrees 2θ, at 25.00, 35.52, 42.93, 45.47, 50.22, 51.00, 56.76, 57.43, 74.12, 80.13, and 81.26.

In some examples, the Fe₃CoB₂ magnetic material has an X-ray diffraction pattern substantially as shown in FIG. 5A.

In some examples, the Fe₃CoB₂ magnetic material exhibits a magnetic anisotropy (K₁) of 1 MJ/m³ or more.

In some examples, the Fe₃CoB₂ magnetic material exhibits a saturation magnetic polarization (Jₛ) of 0.75 Tesla (T) or more or 1 T or more.

In some examples, the Fe₃CoB₂ magnetic material exhibits a Curie temperature of 840 K or more.

In some examples, the Fe₃CoB₂ magnetic material has a formation energy within 100 meV/atom relative to the ternary convex hull.

In some examples, the Fe₃CoB₂ magnetic material exhibits a magnetic anisotropy (K₁) of 1 MJ/m³ or more and a saturation magnetic polarization (Jₛ) of 1 T or more. In some examples, the Fe₃CoB₂ magnetic material exhibits a magnetic anisotropy (K₁) of 1 MJ/m³ or more and a Curie temperature of 840 K or more. In some examples, the Fe₃CoB₂ magnetic material exhibits a magnetic anisotropy (K₁) of 1 MJ/m³ or more and the Fe₃CoB₂ magnetic material has a formation energy within 100 meV/atom relative to the ternary convex hull. In some examples, the Fe₃CoB₂ magnetic material exhibits a saturation magnetic polarization (Jₛ) of 1 T or more and a Curie temperature of 840 K or more. In some examples, the Fe₃CoB₂ magnetic material exhibits a saturation magnetic polarization (Jₛ) of 1 T or more and the Fe₃CoB₂ magnetic material has a formation energy within 100 meV/atom relative to the ternary convex hull. In some examples, the Fe₃CoB₂ magnetic material exhibits a Curie temperature of 840 K or more and the Fe₃CoB₂ magnetic material has a formation energy within 100 meV/atom relative to the ternary convex hull. In some examples, the Fe₃CoB₂ magnetic material exhibits a magnetic anisotropy (K₁) of 1 MJ/m³ or more, a saturation magnetic polarization (Jₛ) of 1 T or more, and a Curie temperature of 840 K or more. In some examples, the Fe₃CoB₂ magnetic material has a magnetic anisotropy (K₁) of 1 MJ/m³ or more, a saturation magnetic polarization (Jₛ) of 1 T or more, and a formation energy within 100 meV/atom relative to the ternary convex hull. In some examples, the Fe₃CoB₂ magnetic material has a saturation magnetic polarization (Jₛ) of 1 T or more, a Curie temperature of 840 K or more, and a formation energy within 100 meV/atom relative to the ternary convex hull. In some examples, the Fe₃CoB₂ magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

In some examples, the Fe₃CoB₂ magnetic material has a high magnetization.

In some examples, the Fe₃CoB₂ magnetic material has a high magnetocrystalline anisotropy energy.

In some examples, the Fe₃CoB₂ magnetic material is substantially free of rare earth elements.

In some examples, the Fe₃CoB₂ magnetic material is dynamically stable.

In some examples, the Fe₃CoB₂ magnetic material has a uniaxial magnetic anisotropy.

In some examples, the Fe₃CoB₂ magnetic material comprises nanoscale to mesoscale crystals.

In some examples, the Fe₃CoB₂ magnetic material is suitable for permanent magnet applications.

In some examples, the Fe₃CoB₂ magnetic material has a ground state ferromagnetic (FM) configuration.

Also disclosed herein are the Fe₃CoB₂ magnetic materials made by any of the methods disclosed herein.

Also disclosed herein are methods of use of any of the magnetic materials disclosed herein or any of the magnetic materials made by any of the methods disclosed herein. In some examples, the method comprises using the magnetic material in an energy generation device, an energy conversion device, an information storage device, an electronic device, an electromechanical device, or a combination thereof. In some examples, the method comprises using the magnetic material in an energy generation and/or energy conversion device, such as a generator, a motor, a mobile machine, a wind turbine, a water turbine, or a combination thereof.

In some examples, the method comprises using the magnetic material in an information storage device and/or an electronic device, such as a computer hard drive and/or a cell phone. In some examples, the method comprises using the magnetic material in an electromechanical device, such as an electric vehicle and/or a hybrid vehicle. In some examples, the method comprises using the magnetic material in medical equipment, spintronics, a home appliance, catalysis, biomedicine, or a combination thereof. In some examples, the method comprises using the magnetic material in an ultra-small spintronics device, a high-density data-storage scheme, a high-energy-product permanent-magnet material, or a combination thereof.

Also disclosed herein are devices or articles of manufacture comprising any of the magnetic materials disclosed herein or any of the magnetic materials made by any of the methods disclosed herein. In some examples, the device or an article of manufacture comprises an energy generation device, an energy conversion device, an information storage device, an electronic device, an electromechanical device, or a combination thereof. In some examples, the device or an article of manufacture comprises an energy generation and/or energy conversion device, such as a generator, a motor, a mobile machine, a wind turbine, a water turbine, or a combination thereof. In some examples, the device or an article of manufacture comprises an information storage device and/or an electronic device, such as a computer hard drive and/or a cell phone. In some examples, the device or an article of manufacture comprises an electromechanical device, such as an electric vehicle and/or a hybrid vehicle. In some examples, the device or an article of manufacture comprises medical equipment, spintronics, a home appliance, a catalytic device, a biomedical device, or a combination thereof. In some examples, the device or an article of manufacture comprises an ultra-small spintronics device, a high-density data-storage scheme, a high-energy-product permanent-magnet material, or a combination thereof.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed compositions and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. The machine learning-guided material discovery framework.

FIG. 2A-FIG. 2C. Formation energy distribution from the crystal graph convolutional neural network (CGCNN) machine learning predictions. (FIG. 2A) Formation energies from the 1G CGCNN machine learning model for structures generated using the Materials Project database. (FIG. 2B) Formation energies from the 2G CGCNN machine learning model for structures generated from the Materials Project database. (FIG. 2C) Formation energies from the 2G CGCNN machine learning model for structures generated by random space groups.

FIG. 3A-FIG. 3D. Energetic stability and magnetic polarization of the Fe—Co—B compound predicted from our machine learning-guided framework. (FIG. 3A) The energy distance from the convex hull, Eₕᵤₗₗ, and (FIG. 3B) magnetic polarization for the 717 first-principles density functional theory (DFT) optimized structures selected from the two generations of CGCNN machine learning models. These structures cover 175 Fe—Co—B compositions. (FIG. 3C) density functional theory formation energy above the convex hull versus the saturation magnetic polarization, Jₛ, for structures from the 1G and 2G CGCNN models. Dotted lines indicate the region of interest (Eₕᵤₗₗ≤0.1 eV/atom and Jₛ≥1 T). (FIG. 3D) density functional theory results of Eₕᵤₗₗ and Jₛ for the structures from two generations of CGCNN models (blue) are compared with those for the structures obtained by adaptive genetic algorithm (red).

FIG. 4A-FIG. 4G. The crystal structures of seven promising Fe—Co—B compounds for permanent magnet obtained from our machine learning-adaptive genetic algorithm-density functional theory predictions. Among these seven structures, four compounds (FIG. 4A, FIG. 4B, FIG. 4E, and FIG. 4G) are discovered by adaptive genetic algorithm searches, and three compounds (FIG. 4C, FIG. 4D, and FIG. 4F) are obtained in the machine learning screening.

FIG. 5A-FIG. 5B. Structural and magnetic properties of Fe₃CoB₂. (FIG. 5A) A comparison of the experimental XRD pattern with the simulated diffraction pattern of the predicted orthorhombic structure (a.u. stands for arbitrary unit). (FIG. 5B) Field-dependent magnetization curve measured at 10 K, where the top inset is the corresponding enlarged magnetization curve to show coercivity H_{c}. The bottom inset shows the fitting of experimental magnetization data (open circles) in the high-field region at 300 K and 10 K using the law-of-approach-to-saturation method (lines) (emu stands for electromagnetic unit).

FIG. 6. A schematic of the melt-spinning process.

FIG. 7: The strategy for machine learning accelerated discovery of new magnetic materials.

FIG. 8A-FIG. 8E: CGCNN for formation energy and magnetization predictions.

FIG. 9: Flowchart for an adaptive genetic algorithm.

FIG. 10A-FIG. 10C. Formation energy distribution predicted by the (FIG. 10A) first, (FIG. 10B) second, and (FIG. 10C) third generation CGCNN models for structures generated from the Materials Project database. The total number of structures is 357 480 in (FIG. 10A) and (FIG. 10B) and 854 070 in (FIG. 10C).

FIG. 11. Convex hull phase diagram. Known stable phases on the convex hull are indicated by black pentagons. Compositions examined by machine learning are labeled with red circles indicating those examined by 1G+2G and blue diamonds by 3G.

FIG. 12A-FIG. 12B. Stability and magnetic polarization of structures from (FIG. 12A) machine learning and (FIG. 12B) adaptive genetic algorithm compared to machine learning. Diamond markers indicate known structures from the Materials Project database.

FIG. 13A-FIG. 13C. machine learning predictions for E_{f} and Jₛ compared to density functional theory results. (FIG. 13A) Formation energies E_{f} and (FIG. 13B) magnetic polarization Jₛ of Fe—Co—Si structures predicted by the 3G-CGCNN model compared to density functional theory calculations. (FIG. 13C) Evolution of the machine learning model over generations. Mean absolute errors in predicting E_{f} and Jₛ are shown in blue and red, respectively.

FIG. 14A-FIG. 14F. Candidate structures with easy-axis anisotropy. Fe, Co, and Si atoms are indicated by yellow, blue, and green spheres, respectively. FIG. 14A-FIG. 14D are the four candidate structures. FIG. 14E stabilizes to FIG. 14F, which has no anisotropy.

FIG. 15A-FIG. 15F. Phonon dispersion of the structures corresponding to FIG. 14A-FIG. 14F, respectively.

FIG. 16A-FIG. 16E. Five Fe—Co—C ternary compounds are predicted to have high magnetization and high magnetic anisotropy suitable for permanent magnet applications.

### DETAILED DESCRIPTION

The compositions and methods described herein may be understood more readily by reference to the following detailed description of specific aspects of the disclosed subject matter and the Examples included therein.

Before the present compositions and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

### Magnetic Materials

Disclosed herein are magnetic materials.

For example, described herein are magnetic materials comprising Fe₄CoSi, Fe₄Co₃Si, FeCo₁₂Si₃, FeCo₆Si, or a combination thereof. In some examples, the magnetic material comprises Fe₄CoSi.

Also disclosed herein are a magnetic materials comprising Fe₁₂Co₄C, Fe₂Co₆C, Fe₄Co₁₂C, Fe₃Co₉C, Fe₂Co₆C, or a combination thereof.

In some examples, the magnetic material exhibits a magnetic anisotropy (K₁) of 1 MJ/m³ or more (e.g., 1.25 MJ/m³ or more, 1.5 MJ/m³ or more, 1.75 MJ/m³ or more, 2 MJ/m³ or more, 2.25 MJ/m³ or more, 2.5 MJ/m³ or more, 2.75 MJ/m³ or more, 3 MJ/m³ or more, 3.25 MJ/m³ or more, 3.5 MJ/m³ or more, 3.75 MJ/m³ or more, 4 MJ/m³ or more, 4.25 MJ/m³ or more, or 4.5 MJ/m³ or more). In some examples, the magnetic material exhibits a magnetic anisotropy (K₁) of 5 MJ/m³ or less (e.g., 4.75 MJ/m³ or less, 4.5 MJ/m³ or less, 4.25 MJ/m³ or less, 4 MJ/m³ or less, 3.75 MJ/m³ or less, 3.5 MJ/m³ or less, 3.25 MJ/m³ or less, 3 MJ/m³ or less, 2.75 MJ/m³ or less, 2.5 MJ/m³ or less, 2.25 MJ/m³ or less, 2 MJ/m³ or less, 1.75 MJ/m³ or less, or 1.5 MJ/m³ or less).

The magnetic anisotropy (K₁) of the magnetic material can range from any of the minimum values described above to any of the maximum values described above. For example, the magnetic material can exhibit a magnetic anisotropy (K₁) of from 1 to 5 MJ/m³ (e.g., from 1 to 3 MJ/m³, from 3 to 5 MJ/m³, from 1 to 2 MJ/m³, from 2 to 3 MJ/m³, from 3 to 4 MJ/m³, from 4 to 5 MJ/m³, from 1 to 4 MJ/m³, from 2 to 5 MJ/m³, from 2 to 4 MJ/m³, from 1.25 to 5 MJ/m³, from 1.5 to 5 MJ/m³, from 1.75 to 5 MJ/m³, from 2 to 5 MJ/m³, from 2.25 to 5 MJ/m³, from 2.5 to 5 MJ/m³, or from 2.75 to 5 MJ/m³).

In some examples, the magnetic material exhibits a saturation magnetic polarization (Jₛ) of 0.75 Tesla (T) or more (e.g., 0.8 T or more, 0.85 T or more, 0.9 T or more, 0.95 T or more, 1 T or more, 1.05 T or more, 1.1 T or more, 1.15 T or more, 1.2 T or more, 1.25 T or more, 1.3 T or more, 1.35 T or more, 1.4 T or more, 1.45 T or more, 1.5 T or more, 1.55 T or more, 1.6 T or more, 1.65 T or more, 1.7 T or more, 1.75 T or more, 1.8 T or more, 1.85 T or more, or 1.9 T or more). In some examples, the magnetic material exhibits a saturation magnetic polarization (Jₛ) of 2 T or less (e.g., 1.95 T or less, 1.9 T or less, 1.85 T or less, 1.8 T or less, 1.75 T or less, 1.7 T or less, 1.65 T or less, 1.6 T or less, 1.55 T or less, 1.5 T or less, 1.45 T or less, 1.4 T or less, 1.35 T or less, 1.3 T or less, 1.25 T or less, 1.2 T or less, 1.15 T or less, 1.1 T or less, 1.05 T or less, 1 T or less, 0.95 T or less, 0.9 T or less, or 0.85 T or less). The saturation magnetic polarization (Jₛ) of the magnetic material can range from any of the minimum values described above to any of the maximum values described above. For example, the magnetic material can exhibit a saturation magnetic polarization (Jₛ) of from 0.75 to 2 T (e.g., from 0.75 to 1.35 T, from 1.35 to 2 T, from 0.75 to 1 T, from 1 to 1.25 T, from 1.25 to 1.5 T, from 1.5 to 1.75 T, from 1.75 to 2 T, from 0.85 to 2 T, from 0.75 to 1.9 T, from 0.85 to 1.9 T, from 1 to 2 T, from 1.25 to 2 T, or from 1.5 to 2 T). In some examples, the magnetic material exhibits a saturation magnetic polarization (Jₛ) of 1 T or more. In some examples, the magnetic material exhibits a saturation magnetic polarization (Jₛ) of from 1 to 2 T.

In some examples, the magnetic material exhibits a Curie temperature of 840 K or more (e.g., 850 K or more, 900 K or more, 950 K or more, 1000 K or more, 1050 K or more, 1100 K or more, 1150 K or more, 1200 K or more, 1250 K or more, 1300 K or more, 1350 K or more, or 1400 K or more). In some examples, the magnetic material exhibits a Curie temperature of 1500 K or less (e.g., 1450 K or less, 1400 K or less, 1350 K or less, 1300 K or less, 1250 K or less, 1200 K or less, 1150 K or less, 1100 K or less, 1050 K or less, 1000 K or less, 950 K or less, or 900 K or less). The Curie temperature of the magnetic material can range from any of the minimum values described above to any of the maximum values described above. For example, the magnetic material can exhibit a Curie temperature of from 840 K to 1500 K (e.g., from 840 to 1150 K, from 1150 to 1500 K, from 840 to 1000 K, from 1000 to 1150 K, from 1150 to 1300 K, from 1300 to 1500 K, from 840 to 1250 K, from 840 to 1000 K, from 850 to 1500 K, from 1000 to 1500 K, from 1250 to 1500 K, from 850 to 1450 K, or from 900 to 1400 K).

In some examples, the magnetic material has a formation energy within 100 meV/atom relative to the ternary convex hull (e.g., within 90 meV/atom, within 80 meV/atom, within 70 meV/atom, within 60 meV/atom, within 50 meV/atom, within 40 meV/atom, within 30 meV/atom, within 20 meV/atom, within or 10 meV/atom).

In some examples, the magnetic material exhibits a magnetic anisotropy (K₁) of 1 MJ/m³ or more and a saturation magnetic polarization (Jₛ) of 1 T or more. In some examples, the magnetic material exhibits a magnetic anisotropy (K₁) of 1 MJ/m³ or more and a Curie temperature of 840 K or more. In some examples, the magnetic material exhibits a magnetic anisotropy (K₁) of 1 MJ/m³ or more and the magnetic material has a formation energy within 100 meV/atom relative to the ternary convex hull. In some examples, the magnetic material exhibits a saturation magnetic polarization (Jₛ) of 1 T or more and a Curie temperature of 840 K or more. In some examples, the magnetic material exhibits a saturation magnetic polarization (Jₛ) of 1 T or more and the magnetic material has a formation energy within 100 meV/atom relative to the ternary convex hull. In some examples, the magnetic material exhibits a Curie temperature of 840 K or more and the magnetic material has a formation energy within 100 meV/atom relative to the ternary convex hull.

In some examples, the magnetic material exhibits a magnetic anisotropy (K₁) of 1 MJ/m³ or more, a saturation magnetic polarization (Jₛ) of 1 T or more, and a Curie temperature of 840 K or more. In some examples, the magnetic material has a magnetic anisotropy (K₁) of 1 MJ/m³ or more, a saturation magnetic polarization (Jₛ) of 1 T or more, and a formation energy within 100 meV/atom relative to the ternary convex hull. In some examples, the magnetic material has a saturation magnetic polarization (Jₛ) of 1 T or more, a Curie temperature of 840 K or more, and a formation energy within 100 meV/atom relative to the ternary convex hull.

In some examples, the magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

In some examples, the magnetic material has a high magnetization.

In some examples, the magnetic material has a high magnetocrystalline anisotropy energy.

In some examples, the magnetic material is substantially free of rare earth elements.

In some examples, the magnetic material is dynamically stable.

In some examples, the magnetic material has a uniaxial magnetic anisotropy.

In some examples, the magnetic material comprises nanoscale to mesoscale crystals.

In some examples, the magnetic material is suitable for permanent magnet applications.

In some examples, the magnetic material has a ground state ferromagnetic (FM) configuration.

### Methods of Making

Also disclosed herein are methods of making any of the magnetic materials disclosed herein.

In some examples, the method comprises a nonequilibrium synthesis method.

In some examples, the method comprises chemical solution synthesis, sputtering, arc melting, or a combination thereof.

In some examples, the method comprises salt-matrix annealing, surfactant-assisted ball milling, or a combination thereof.

In some examples, the method comprises high-temperature high-pressure hydro/solvent-thermal synthesis.

In some examples, the method comprises rapid quenching from a melt to thereby produce a magnetic materials with equilibrium or metastable structures.

In some examples, the method comprises: combining appropriate amount of high-purity elements to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to rapidly cool the re-melted preliminary alloy to thereby form the magnetic material.

Methods of Making Fe₃CoB₂

Also disclosed herein are methods of making a magnetic material comprising Fe₃CoB₂. In some examples, the methods comprise: combining appropriate amount of high-purity Fe, Co, and B to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to cool the re-melted preliminary alloy to thereby form the Fe₃CoB₂ magnetic material.

In some examples, the surface of a water-cooled rotating wheel to cool the re-melted preliminary alloy at a cooling rate of 1×10⁴ K/s or more (e.g., 2×10⁴ K/s or more, 3×10⁴ K/s or more, 4×10⁴ K/s or more, 5×10⁴ K/s or more, 6×10⁴ K/s or more, 7×10⁴ K/s or more, 8×10⁴ K/s or more, 9×10⁴ K/s or more, 1×10⁵ K/s or more, 2×10⁵ K/s or more, 3×10⁵ K/s or more, 4×10⁵ K/s or more, 5×10⁵ K/s or more, 6×10⁵ K/s or more, 7×10⁵ K/s or more, 8×10⁶ K/s or more, 9×10⁶ K/s or more, 1×10⁶ K/s or more, 2×10⁶ K/s or more, 3×10⁶ K/s or more, 4×10⁶ K/s or more, 5×10⁶ K/s or more, 6×10⁶ K/s or more, 7×10⁶ K/s or more, 8×10⁶ K/s or more, 9×10⁶ K/s or more, 1×10⁷ K/s or more, 2×10⁷ K/s or more, 3×10⁷ K/s or more, 4×10⁷ K/s or more, 5×10⁷ K/s or more, 6×10⁷ K/s or more, 7×10⁷ K/s or more, 8×10⁷ K/s or more, or 9×10⁷ K/s or more). In some examples, the surface of a water-cooled rotating wheel to cool the re-melted preliminary alloy at a cooling rate of 1×10⁸ K/s or less (e.g., 9×10⁷ K/s or less, 8×10⁷ K/s or less, 7×10⁷ K/s or less, 6×10⁷ K/s or less, 5×10⁷ K/s or less, 4×10⁷ K/s or less, 3×10⁷ K/s or less, 2×10⁷ K/s or less, 1×10⁷ K/s or less, 9×10⁶ K/s or less, 8×10⁶ K/s or less, 7×10⁶ K/s or less, 6×10⁶ K/s or less, 5×10⁶ K/s or less, 4×10⁶ K/s or less, 3×10⁶ K/s or less, 2×10⁶ K/s or less, 1×10⁶ K/s or less, 9×10⁵ K/s or less, 8×10⁵ K/s or less, 7×10⁵ K/s or less, 6×10⁵ K/s or less, 5×10⁵ K/s or less, 4×10⁵ K/s or less, 3×10⁵ K/s or less, 2×10⁵ K/s or less, 1×10⁵ K/s or less, 9×10⁴ K/s or less, 8×10⁴ K/s or less, 7×10⁴ K/s or less, 6×10⁴ K/s or less, 5×10⁴ K/s or less, 4×10⁴ K/s or less, 3×10⁴ K/s or less, or 2×10⁴ K/s or less). The rate at which the surface of a water-cooled rotating wheel is cooled to cool the re-melted preliminary alloy can range from any of the minimum values described above to any of the maximum values described above. For example, the surface of a water-cooled rotating wheel to cool the re-melted preliminary alloy at a cooling rate of from 1×10⁴ to 1×10⁸ K/s (e.g., from 1×10⁴ K/s to 1×10⁶ K/s, from 1×10⁶ K/s to 1×10⁸ K/s, from 1×10⁴ K/s to 1×10⁵ K/s, from 1×10⁵ K/s to 1×10⁶ K/s, from 1×10⁶ K/s to 1×10⁷ K/s, from 1×10⁷ K/s to 1×10⁸ K/s, from 1×10⁵ to 1×10⁸ K/s, from 1×10⁴ to 1×10⁷ K/s, from 1×10⁵ K/s to 5×10⁶ K/s, from 5×10⁶ K/s to 1×10⁸ K/s, from 1×10⁵ K/s to 1×10⁶ K/s, from 1×10⁶ K/s to 1×10⁷ K/s, from 1×10⁷ K/s to 1×10⁸ K/s, from 1×10⁵ K/s to 5×10⁷ K/s, from 5×10⁵ K/s to 1×10⁸ K/s, from 5×10⁵ K/s to 5×10⁷ K/s, or from 1×10⁴ to 1×10⁶ K/s). In some examples, the surface of a water-cooled rotating wheel to cool the re-melted preliminary alloy at a cooling rate of from 1×10⁵ to 1×10⁸ K/s. In some examples, the surface of a water-cooled rotating wheel to cool the re-melted preliminary alloy at a cooling rate of from 1×10⁴ to 1×10⁶ K/s.

In some examples, the water-cooled rotating wheel is rotated at a rate of 20 m/s or more (e.g., 22 m/s or more, 24 m/s or more, 26 m/s or more, 28 m/s or more, 30 m/s or more, 32 m/s or more, 34 m/s or more, 36 m/s or more, or 38 m/s or more). In some examples, the water-cooled rotating wheel is rotated at a rate of 40 m/s or less (e.g., 38 m/s or less, 36 m/s or less, 34 m/s or less, 32 m/s or less, 30 m/s or less, 28 m/s or less, 26 m/s or less, 24 m/s or less, or 22 m/s or less). The rate at which the water-cooled rotating wheel is rotated can range from any of the minimum values described above to any of the maximum values described above. For example, the water-cooled rotating wheel can be rotated at a rate of from 20 to 40 m/s (e.g., from 20 to 30 m/s, from 30 to 40 m/s, from 20 to 25 m/s, from 25 to 30 m/s, from 30 to 35 m/s, from 35 to 40 m/s, from 25 to 40 m/s, from 20 to 35 m/s, or from 25 to 35 m/s).

In some examples, rapid quenching from the re-melted preliminary alloy thereby produce the Fe₃CoB₂ magnetic material with equilibrium or metastable structures.

In some examples, the method comprises a nonequilibrium synthesis method.

In some examples, the Fe₃CoB₂ magnetic material has an X-ray diffraction pattern comprising characteristic peaks, in terms of plus or minus 0.05 degrees 2θ, at 25.00, 35.52, 42.93, 45.47, 50.22, 51.00, 56.76, 57.43, 74.12, 80.13, and 81.26.

In some examples, the Fe₃CoB₂ magnetic material has an X-ray diffraction pattern substantially as shown in FIG. 5A.

In some examples, the Fe₃CoB₂ magnetic material exhibits a magnetic anisotropy (K₁) of 1 MJ/m³ or more (e.g., 1.25 MJ/m³ or more, 1.5 MJ/m³ or more, 1.75 MJ/m³ or more, 2 MJ/m³ or more, 2.25 MJ/m³ or more, 2.5 MJ/m³ or more, 2.75 MJ/m³ or more, 3 MJ/m³ or more, 3.25 MJ/m³ or more, 3.5 MJ/m³ or more, 3.75 MJ/m³ or more, 4 MJ/m³ or more, 4.25 MJ/m³ or more, or 4.5 MJ/m³ or more). In some examples, the Fe₃CoB₂ magnetic material exhibits a magnetic anisotropy (K₁) of 5 MJ/m³ or less (e.g., 4.75 MJ/m³ or less, 4.5 MJ/m³ or less, 4.25 MJ/m³ or less, 4 MJ/m³ or less, 3.75 MJ/m³ or less, 3.5 MJ/m³ or less, 3.25 MJ/m³ or less, 3 MJ/m³ or less, 2.75 MJ/m³ or less, 2.5 MJ/m³ or less, 2.25 MJ/m³ or less, 2 MJ/m³ or less, 1.75 MJ/m³ or less, or 1.5 MJ/m³ or less). The magnetic anisotropy (K₁) of the Fe₃CoB₂ magnetic material can range from any of the minimum values described above to any of the maximum values described above. For example, the Fe₃CoB₂ magnetic material can exhibit a magnetic anisotropy (K₁) of from 1 to 5 MJ/m³ (e.g., from 1 to 3 MJ/m³, from 3 to 5 MJ/m³, from 1 to 2 MJ/m³, from 2 to 3 MJ/m³, from 3 to 4 MJ/m³, from 4 to 5 MJ/m³, from 1 to 4 MJ/m³, from 2 to 5 MJ/m³, from 2 to 4 MJ/m³, from 1.25 to 5 MJ/m³, from 1.5 to 5 MJ/m³, from 1.75 to 5 MJ/m³, from 2 to 5 MJ/m³, from 2.25 to 5 MJ/m³, from 2.5 to 5 MJ/m³, or from 2.75 to 5 MJ/m³).

In some examples, the Fe₃CoB₂ magnetic material exhibits a saturation magnetic polarization (Jₛ) of 0.75 Tesla (T) or more (e.g., 0.8 T or more, 0.85 T or more, 0.9 T or more, 0.95 T or more, 1 T or more, 1.05 T or more, 1.1 T or more, 1.15 T or more, 1.2 T or more, 1.25 T or more, 1.3 T or more, 1.35 T or more, 1.4 T or more, 1.45 T or more, 1.5 T or more, 1.55 T or more, 1.6 T or more, 1.65 T or more, 1.7 T or more, 1.75 T or more, 1.8 T or more, 1.85 T or more, or 1.9 T or more). In some examples, the Fe₃CoB₂ magnetic material exhibits a saturation magnetic polarization (Jₛ) of 2 T or less (e.g., 1.95 T or less, 1.9 T or less, 1.85 T or less, 1.8 T or less, 1.75 T or less, 1.7 T or less, 1.65 T or less, 1.6 T or less, 1.55 T or less, 1.5 T or less, 1.45 T or less, 1.4 T or less, 1.35 T or less, 1.3 T or less, 1.25 T or less, 1.2 T or less, 1.15 T or less, 1.1 T or less, 1.05 T or less, 1 T or less, 0.95 T or less, 0.9 T or less, or 0.85 T or less). The saturation magnetic polarization (Jₛ) of the Fe₃CoB₂ magnetic material can range from any of the minimum values described above to any of the maximum values described above. For example, the Fe₃CoB₂ magnetic material can exhibit a saturation magnetic polarization (Jₛ) of from 0.75 to 2 T (e.g., from 0.75 to 1.35 T, from 1.35 to 2 T, from 0.75 to 1 T, from 1 to 1.25 T, from 1.25 to 1.5 T, from 1.5 to 1.75 T, from 1.75 to 2 T, from 0.85 to 2 T, from 0.75 to 1.9 T, from 0.85 to 1.9 T, from 1 to 2 T, from 1.25 to 2 T, or from 1.5 to 2 T). In some examples, the Fe₃CoB₂ magnetic material exhibits a saturation magnetic polarization (Jₛ) of 1 T or more. In some examples, the Fe₃CoB₂ magnetic material exhibits a saturation magnetic polarization (Jₛ) of from 1 to 2 T.

In some examples, the Fe₃CoB₂ magnetic material exhibits a Curie temperature of 840 K or more (e.g., 850 K or more, 900 K or more, 950 K or more, 1000 K or more, 1050 K or more, 1100 K or more, 1150 K or more, 1200 K or more, 1250 K or more, 1300 K or more, 1350 K or more, or 1400 K or more). In some examples, the Fe₃CoB₂ magnetic material exhibits a Curie temperature of 1500 K or less (e.g., 1450 K or less, 1400 K or less, 1350 K or less, 1300 K or less, 1250 K or less, 1200 K or less, 1150 K or less, 1100 K or less, 1050 K or less, 1000 K or less, 950 K or less, or 900 K or less). The Curie temperature of the Fe₃CoB₂ magnetic material can range from any of the minimum values described above to any of the maximum values described above. For example, the Fe₃CoB₂ magnetic material can exhibit a Curie temperature of from 840 K to 1500 K (e.g., from 840 to 1150 K, from 1150 to 1500 K, from 840 to 1000 K, from 1000 to 1150 K, from 1150 to 1300 K, from 1300 to 1500 K, from 840 to 1250 K, from 840 to 1000 K, from 850 to 1500 K, from 1000 to 1500 K, from 1250 to 1500 K, from 850 to 1450 K, or from 900 to 1400 K).

In some examples, the Fe₃CoB₂ magnetic material has a formation energy within 100 meV/atom relative to the ternary convex hull (e.g., within 90 meV/atom, within 80 meV/atom, within 70 meV/atom, within 60 meV/atom, within 50 meV/atom, within 40 meV/atom, within 30 meV/atom, within 20 meV/atom, within or 10 meV/atom).

In some examples, the Fe₃CoB₂ magnetic material exhibits a magnetic anisotropy (K₁) of 1 MJ/m³ or more and a saturation magnetic polarization (Jₛ) of 1 T or more. In some examples, the Fe₃CoB₂ magnetic material exhibits a magnetic anisotropy (K₁) of 1 MJ/m³ or more and a Curie temperature of 840 K or more. In some examples, the Fe₃CoB₂ magnetic material exhibits a magnetic anisotropy (K₁) of 1 MJ/m³ or more and the Fe₃CoB₂ magnetic material has a formation energy within 100 meV/atom relative to the ternary convex hull. In some examples, the Fe₃CoB₂ magnetic material exhibits a saturation magnetic polarization (Jₛ) of 1 T or more and a Curie temperature of 840 K or more. In some examples, the Fe₃CoB₂ magnetic material exhibits a saturation magnetic polarization (Jₛ) of 1 T or more and the Fe₃CoB₂ magnetic material has a formation energy within 100 meV/atom relative to the ternary convex hull.

In some examples, the Fe₃CoB₂ magnetic material exhibits a Curie temperature of 840 K or more and the Fe₃CoB₂ magnetic material has a formation energy within 100 meV/atom relative to the ternary convex hull. In some examples, the Fe₃CoB₂ magnetic material exhibits a magnetic anisotropy (K₁) of 1 MJ/m³ or more, a saturation magnetic polarization (Jₛ) of 1 T or more, and a Curie temperature of 840 K or more. In some examples, the Fe₃CoB₂ magnetic material has a magnetic anisotropy (K₁) of 1 MJ/m³ or more, a saturation magnetic polarization (Jₛ) of 1 T or more, and a formation energy within 100 meV/atom relative to the ternary convex hull. In some examples, the Fe₃CoB₂ magnetic material has a saturation magnetic polarization (Jₛ) of 1 T or more, a Curie temperature of 840 K or more, and a formation energy within 100 meV/atom relative to the ternary convex hull.

In some examples, the Fe₃CoB₂ magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

In some examples, the Fe₃CoB₂ magnetic material has a high magnetization. In some examples, the Fe₃CoB₂ magnetic material has a high magnetocrystalline anisotropy energy. In some examples, the Fe₃CoB₂ magnetic material is substantially free of rare earth elements. In some examples, the Fe₃CoB₂ magnetic material is dynamically stable. In some examples, the Fe₃CoB₂ magnetic material has a uniaxial magnetic anisotropy. In some examples, the Fe₃CoB₂ magnetic material comprises nanoscale to mesoscale crystals. In some examples, the Fe₃CoB₂ magnetic material is suitable for permanent magnet applications. In some examples, the Fe₃CoB₂ magnetic material has a ground state ferromagnetic (FM) configuration.

Also disclosed herein is the Fe₃CoB₂ magnetic material made by any of the methods disclosed herein.

### Methods of Use

Also disclosed herein are methods of use of any of the magnetic materials disclosed herein and/or any of the magnetic materials made by any of the methods disclosed herein. For example, also disclosed herein are methods of use of any of the magnetic materials disclosed herein, for example in a system, an article, and/or a device.

In some examples, the method comprises using the magnetic material in an energy generation device, an energy conversion device, an information storage device, an electronic device, an electromechanical device, or a combination thereof.

In some examples, the method comprises using the magnetic material in an energy generation and/or energy conversion device, such as a generator, a motor, a mobile machine, a wind turbine, a water turbine, or a combination thereof.

In some examples, the method comprises using the magnetic material in an information storage device and/or an electronic device, such as a computer hard drive and/or a cell phone.

In some examples, the method comprises using the magnetic material in an electromechanical device, such as an electric vehicle and/or a hybrid vehicle.

In some examples, the method comprises using the magnetic material in medical equipment, spintronics, a home appliance, catalysis, biomedicine, or a combination thereof.

In some examples, the method comprises using the magnetic material in an ultra-small spintronics device, a high-density data-storage scheme, a high-energy-product permanent-magnet material, or a combination thereof.

Also disclosed herein are devices and/or articles of manufacture comprising any of the magnetic materials and/or the magnetic materials made by any of the methods disclosed herein.

In some examples, the device or an article of manufacture comprises an energy generation device, an energy conversion device, an information storage device, an electronic device, an electromechanical device, or a combination thereof.

In some examples, the device or an article of manufacture comprises an energy generation and/or energy conversion device, such as a generator, a motor, a mobile machine, a wind turbine, a water turbine, or a combination thereof.

In some examples, the device or an article of manufacture comprises an information storage device and/or an electronic device, such as a computer hard drive and/or a cell phone.

In some examples, the device or an article of manufacture comprises an electromechanical device, such as an electric vehicle and/or a hybrid vehicle.

In some examples, the device or an article of manufacture comprises medical equipment, spintronics, a home appliance, a catalytic device, a biomedical device, or a combination thereof.

In some examples, the device or an article of manufacture comprises an ultra-small spintronics device, a high-density data-storage scheme, a high-energy-product permanent-magnet material, or a combination thereof.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. There are numerous variations and combinations of measurement conditions, e.g., component concentrations, temperatures, pressures and other measurement ranges and conditions that can be used to optimize the described process.

### Example 1—Accelerating the Discovery of Novel Magnetic Materials Using Machine Learning-Guided Adaptive Feedback

Magnetic materials are essential for energy generation and information devices, and they play an important role in advanced technologies and green energy economies. Currently, the most widely used magnets contain rare earth (RE) elements. An outstanding challenge of notable scientific interest is the discovery and synthesis of new magnetic materials without rare earth elements that meet the performance and cost goals for advanced electromagnetic devices. Here, discovery and synthesis is reported of a rare earth-free magnetic compound, Fe₃CoB₂, through an efficient feedback framework by integrating machine learning (ML), an adaptive genetic algorithm, first-principles calculations, and experimental synthesis. Magnetic measurements show that Fe₃CoB₂ exhibits a high magnetic anisotropy (K₁=1.2 MJ/m³) and saturation magnetic polarization (Jₛ=1.39 T), which is suitable for rare earth-free permanent-magnet applications. The machine learning-guided approach presents a promising paradigm for efficient materials design and discovery and can also be applied to the search for other functional materials.

Discovering rare earth (RE)—free magnets that can meet the performance and cost goals for advanced electromagnetic devices has been the dream of many scientists over several decades. Presented herein is the efficient discovery and synthesis of a rare earth-free magnetic Fe₃CoB₂ compound. A machine learning (ML)—guided framework greatly reduces the complexity of high-throughput screening and makes ab initio calculations and further structure searches using an adaptive genetic algorithm much more effective than previous approaches. It is demonstrated that the machine learning-guided framework enables the computational discovery and experimental synthesis of an Fe₃CoB₂ compound to be accomplished in days. The machine learning-guided framework presents a paradigm for efficient materials design and discovery in the digital era.

Computational-driven discovery of novel materials with targeted functionalities is a highly active research area owing to rapid advances in computer and communication technologies, machine learning (ML) algorithms, and data sciences. For accelerating the speed of materials discovery, it is essential to efficiently establish the relationships among chemical compositions, crystal structures, and physical properties. In the past few decades, several efficient computational algorithms including an adaptive genetic algorithm (AGA) have been developed to predict stable crystal structures based on given chemical compositions (1-4). These algorithms and methods are very useful in guiding materials discovery (5-7). However, the number of possible combinations of different elements with different compositions, and the crystal structures that they may adopt, is enormous, especially for compounds with three or more chemical species. Using existing structural search algorithms to examine all possible compositions is not realistic, and the chance to discover desired materials by conventional methods can be extremely low. Complementary high-throughput computational approaches for materials discovery have also been developed. Such approaches can cover a wide range of compositions through exploring a large number of compounds obtained by the substitution of various chemical species into known crystal-structure lattices. First-principles calculations in combination with machine learning analyses are then performed to identify compounds with desired functionalities. Successful examples of such approaches have been reported in the literature (8-15). A disadvantage of such high-throughput approaches is that most of the substitutional structures are not energetically favorable, and first-principles calculations on these uninteresting structures are costly and ineffective.

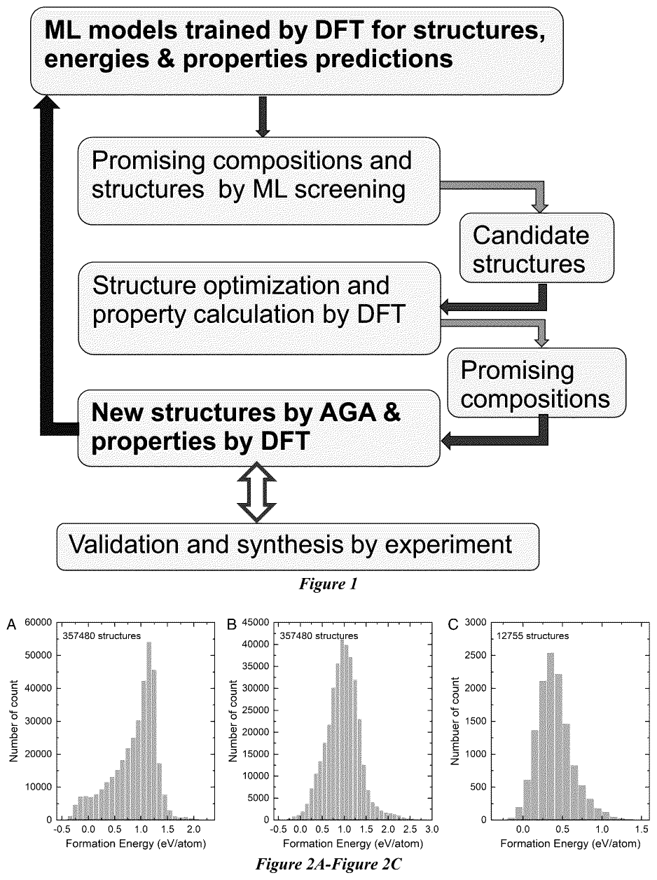

An outstanding challenge is to develop a robust strategy to effectively guide a rapid selection of promising compositions that can yield stable crystal structures with targeted physical properties. Herein, a machine learning-guided framework was developed that can efficiently accelerate the discovery of materials, as outlined in FIG. 1. The framework was initiated with a machine learning model trained using existing first-principles density functional theory (DFT) calculation data from popular public databases. This machine learning model can provide the rapid prediction of chemical compositions and crystal structures that are likely to exhibit desirable energetic stability (i.e., formation energies) and functionalities. Plausible candidates obtained from the machine learning screening are validated by first-principles calculations before promising ones are selected for further crystal structure searches using an adaptive genetic algorithm to discover more lower-energy structures based on the selected chemical compositions. Moreover, new low-energy structures and their properties obtained from adaptive genetic algorithm and first-principles calculations can be used to adaptively refine the machine learning model, with the success rate of the prediction improved adaptively.

The efficiency of this machine learning-guided feedback framework for materials discovery is demonstrated by searching for new rare earth-free magnetic materials. Although there have been a number of studies on high-throughput calculations in combination with machine learning for magnetic materials (16-24), an efficient machine learning-guided framework for greatly accelerating the discovery and synthesis of new materials is still highly desired. Specifically, an Fe—Co—B system was considered. An aim is to find new ternary compounds with favorable energetic stability and desired magnetic properties, such as high magnetization and high magnetocrystalline anisotropy energy (MAE), like rare earth magnets such as Nd₂Fe₁₄B and SmCo₅. Fe-based magnetic materials are attractive, owing to the abundance of Fe and its large atomic magnetic moment. Fe—Co binary alloys are good candidates for ferromagnetic materials. However, they are generally stabilized in cubic structures and exhibit low magnetic anisotropy. Considerable effort has been devoted to combine a third element with Fe and Co to stabilize noncubic ternary structures with a high magnetocrystalline anisotropy. For example, an incorporation of N in FeCo thin films and nanoparticles leads to tetragonal structures with improved magnetocrystalline anisotropies (25, 26). Unfortunately, Fe—Co—N compounds can decompose at higher temperatures of above 500 K (26, 27). The synthesis of bulk Fe—Co—N compounds remains challenging and has yet to be realized. Binary or ternary compounds formed by combining Fe, Co, or FeCo with transition metals such as Zr, Hf, Ti, and Nb also exhibit appreciable magnetocrystalline anisotropies, but their saturation magnetizations are significantly reduced compared to those of Fe and Co (5, 7). For the Fe—Co—B system, no stable ternary structures with desired magnetic properties for permanent-magnet applications have been discovered.

Prior to performing an adaptive genetic algorithm search, a machine learning model was utilized to select promising compositions for stable magnetic Fe—Co—B ternary compounds. The machine learning model provides a rapid screening over a wide range of possible compositions and crystalline structures to select chemical compositions and crystal structures with desirable formation energies. Consequent density functional theory optimizations based on the short list of candidate structures selected by machine learning screening provides information on the magnetic properties of the candidate structures. Here, the crystal graph convolutional neural network (CGCNN) method was adopted (28). In CGCNN, a crystal structure is represented by a crystal graph that encodes both atomic information and bonding interactions between atoms. A convolutional neural network (CNN) is added on top of the crystal graph to construct the proper descriptors, which are optimal for predicting target properties. In this way, composition-structure-property relationships can be efficiently learned and predicted by CGCNN. The training data in CGCNN are primarily generated by first-principles calculations, which enables a sufficient volume for the supervision training.

First the parameters in the CGCNN model developed for formation energy predictions of compounds were adopted (28). This CGCNN model was trained by using the available structures and density functional theory-calculated formation energies of 28,046 structures from the Materials Project (MP) database (29). This model is referred to herein as the first-generation (1G) CGCNN model. Then, 11,916 known ternary structures were extracted from the MP database and the three elements were replaced with Fe, Co, and B to predict the formation energies of ternary Fe—Co—B compounds using the CGCNN machine learning model. There are six ways to shuffle the order of three elements into a given ternary structure. The volume of the crystals was allowed to vary by a scaling factor between 0.96 and 1.04 with an interval of 0.02. Therefore, a total of 357,480 hypothetical Fe—Co—B structures are investigated by CGCNN. Noting that the CGCNN model does not have the interatomic forces to relax the bond lengths of the structure, the use of a scaling factor for the volume here allows the CGCNN model to differentiate the energetic stability of the same structure with different bond lengths. The formation energy distribution from the 1G CGCNN prediction for this set of structures is shown in FIG. 2A, where the CGCNN screening suggests that 435 Fe—Co—B structures have negative formation energies. After removing very similar structures, 400 structures from this short list are selected for subsequent density functional theory calculations.

A CGCNN machine learning model was also trained specifically for predicting Fe—Co—based ternary compounds using density functional theory formation energies of the 400 Fe—Co—B structures from the 1G CGCNN model and those of 3,469 Fe—Co—X (X=C, N, Si, and S) ternary structures from a magnetic materials database (30). This CGCNN model is referred to herein as the second-generation (2G) CGCNN model. The 2G CGCNN model was applied to the set of 357,480 structures generated from the Materials Project database discussed above and to another set of 12,755 ternary structures generated by a random generation algorithm (31). The formation energy distribution from the 2G-CGCNN model on these two sets of structures are shown in FIG. 2B and FIG. 2C, respectively. Additional 2,125 structures that have negative formation energies from the 2G-CGCNN machine learning model are selected for subsequent density functional theory structure optimizations. The existing FeCoB, FeCoB₂, and Fe₃Co₃B₂ compounds reported in previous work (32) and the FeCo₂B compound in an earlier study (33) are all captured from the 1G and 2G-CGCNN predictions.

After carrying out density functional theory structure optimizations, 147 and 570 fully relaxed distinct Fe—Co—B structures were obtained from the 1G- and 2G-CGCNN screenings, respectively. These 717 structures cover 175 different Fe—Co—B compositions.

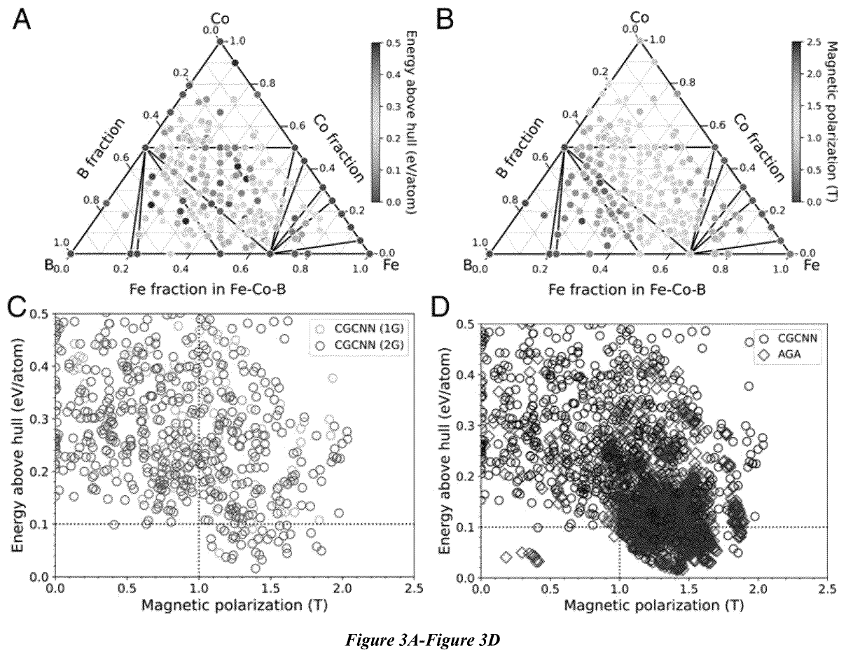

It is noted that the formation energy E_{f} used in the CGCNN is defined with respect to the elementary Fe, Co, and B crystal phases. A negative formation energy means that the structure is unlikely to be decomposed into the three elementary crystalline phases, while a positive formation energy means that the structure is likely to be decomposed into the three elementary crystalline phases. To further assess the energetic stability of the relaxed structures at different compositions, the density functional theory formation energy with respect to the known convex hull (denoted as Eₕᵤₗₗ) is also calculated for the CGCNN-predicted 717 ternary structures, as shown in FIG. 3A. The Eₕᵤₗₗ of any given phase on the ternary convex hull is calculated by comparing its formation energy with respect to the nearby three known phases on the convex hull (ternary, binary, or elementary crystalline phases), and the chemical compositions of these three phases are located at the vertexes of a triangle (the Gibbs triangle), which enclose the composition of the phase of which Eₕᵤₗₗ is being calculated. Eₕᵤₗₗ was used to assess the thermodynamic stability of the given phase against decomposition into the nearby three known phases.

It can be seen from FIG. 3A that many of these Fe—Co—B ternary structures exhibit a formation energy very close to the convex hull. Such energetically favorable metastable structures could be synthesized by experiments using nonequilibrium synthesis methods. In FIG. 3B, the magnetization of these structures from density functional theory calculations is also shown.

In the present study, only ferromagnetic configurations are used for the density functional theory calculations. This should be a reasonable choice used to quickly select promising candidate structures for permanent magnets. The magnetic polarization is obtained by dividing the total magnetic moment in the unit cell from the density functional theory calculations by the volume of the unit cell. Many of these structures, especially those with rich Fe or/and Co compositions, exhibit high magnetization Jₛ larger than 1 T.

To assess which structure has both favorable energetic stability and magnetization, a scatterplot was constructed with magnetization shown as the horizontal axis and formation energy with respect to the convex hull as the vertical axis (FIG. 3C). From machine learning screening with the CGCNN models 36 promising structures (Eₕᵤₗₗ≤0.1 eV/atom and Jₛ≥1 T) were discovered in FIG. 3C (Right, Bottom) based on the results from density functional theory calculations.

It was also found that the 36 promising structures predicted with the guidance from CGCNN cover 22 compositions out of 175 compositions examined by CGCNN. Therefore these 22 compositions were selected for further investigation by adaptive genetic algorithm, thus substantially narrowing the number of compositions to be explored in adaptive genetic algorithm searches. Based on the 22 compositions, 1,817 structures were generated using an adaptive genetic algorithm. After density functional theory optimizations, 557 new metastable structures with Eₕᵤₗₗ≤0.1 eV/atom and a high magnetization, Jₛ≥1 T were obtained, as shown in FIG. 3D. Compared to the 36 structures discovered through machine learning screening as discussed in the paragraph above, more new promising structures are discovered by the adaptive genetic algorithm, as shown in FIG. 3D. Therefore, with the guidance from machine learning to select promising compositions, the adaptive genetic algorithm plays an important role in discovery of new materials in this framework. With the combined machine learning+adaptive genetic algorithm+density functional theory (ML+AGA+DFT) approach, almost every possible low-energy structure can be efficiently retrieved over a wide range of compositions in this ternary system. As shown in FIG. 3D, 593 Fe—Co—B structures with Eₕᵤₗₗ≤0.1 eV/atom were discovered. Such low-energy metastable structures could be synthesized by experimentation, especially under nonequilibrium synthesis conditions. Moreover, more than 90% of the adaptive genetic algorithm-derived structures have a high magnetization (Jₛ≥1 T).

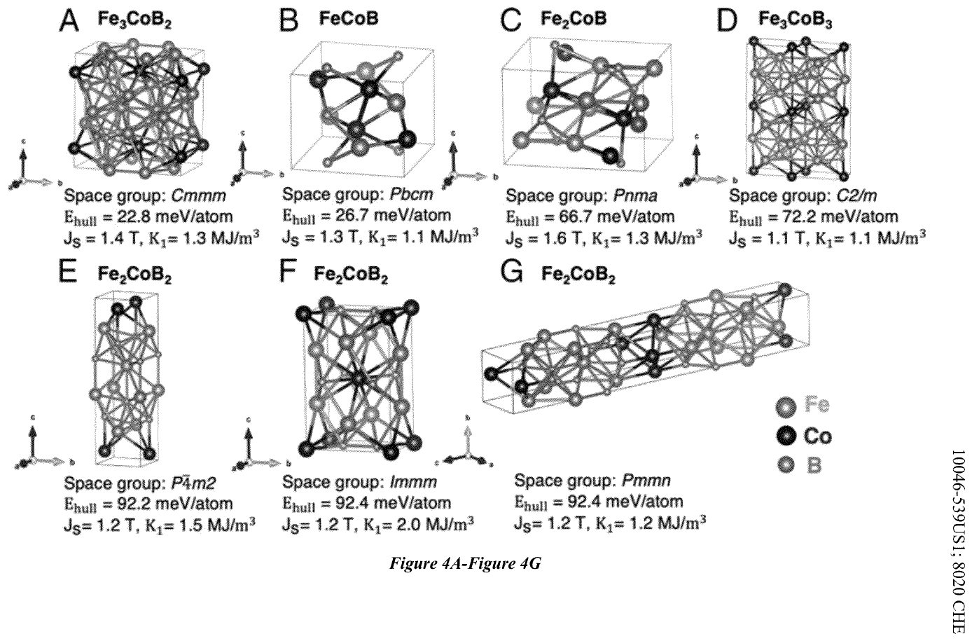

Density functional theory calculations with the spin-orbit interactions were performed to estimate the magnetocrystalline anisotropy energy for noncubic structures from the 593 candidate structures with Eₕᵤₗₗ≤0.1 eV/atom and Jₛ≥1 T. As discussed above, among these 593 structures, 36 are from CGCNN and 557 are from adaptive genetic algorithm. It was found that seven structures possess a large magnetocrystalline anisotropy energy of K₁>1 MJ/m³. Among them, three compounds (shown in FIG. 4C, FIG. 4D, and FIG. 4F) are from the CGCNN prediction and four compounds including the best Fe₃CoB₂ (shown in FIG. 4A, FIG. 4B, FIG. 4E, and FIG. 4G) are found by the adaptive genetic algorithm searches. Six of them have a tetragonal or orthorhombic lattice, exhibiting uniaxial anisotropy. Uniaxial anisotropy plays a key role in yielding magnetic coercivity, a measure of a resistance to being demagnetized. The seven Fe—Co—B structures predicted from the scheme have a magnetocrystalline anisotropy energy substantially larger than that of hexagonal close packed Co (0.44 MJ/m³), which is favorable for permanent-magnet applications. In particular, as shown in FIG. 4A and Table 1, the Fe₃CoB₂ compound exhibits the lowest formation energy above the convex hull (22.8 meV/atom) as compared to other high-magnetocrystalline anisotropy energy compounds. The Fe₃CoB₂ compound is an orthorhombic structure with a space group Cmmm and lattice parameters of a=4.211, b=7.078, and c=7.149 Å, as schematically shown in FIG. 4A. Phonon dispersion calculations were for this structure and the results indicated that the structure is dynamically stable.

TABLE 1
Space group, formula units per unit cell [Z], formation
energy [E_{f}], Eₕᵤₗₗ, and magnetic properties (magnetic
polarization [Jₛ], magnetic anisotropy
energy [K₁], magnetic easy axis, and
T_{c} of the seven promising Fe—Co—B
compounds discovered through the
combined ML-AGA-DFT scheme.

| | | | E_{f} | | Magnetic Properties | | | |
|---|---|---|---|---|---|---|---|---|
| | Space Group | | E_{f} | Eₕᵤₗₗ | Jₛ | K₁ | Easy | T_{c} |
| Formula | (No.) | Z | (meV/atom) | (meV/atom) | (T) | (MJ/m³) | Axis | (K) |
| Fe | Im3̅m (229) | 1 | 0 | 0 | 2.15 | | | 1043 |
| Co | P6₃/mmc (194) | 2 | 0 | 0 | 1.81 | 0.41 | c | 1388 |
| Fe₃CoB₂ | Cmmm (65) | 4 | −283.7 | 22.8 | 1.40 | 1.34 | a | 1252 |
| [FIG. 4A] | | | | | | | | |
| FeCoB | Pbcm (57) | 4 | −274.1 | 26.7 | 1.34 | 1.07 | c | 928 |
| [FIG. 4B] | | | | | | | | |
| Fe₂CoB | Pnma (62) | 4 | −180.3 | 66.7 | 1.55 | 1.32 | b | 881 |
| [FIG. 4C] | | | | | | | | |
| Fe₃CoB₃ | C2/m (12) | 4 | −288.2 | 72.2 | 1.08 | 1.12 | c | 643 |
| [FIG. 4D] | | | | | | | | |
| Fe₂CoB₂ | Immm (71) | 2 | −258.4 | 92.4 | 1.15 | 1.96 | b | 789 |
| [FIG. 4E] | | | | | | | | |
| Fe₂CoB₂ | Pmmn (59) | 2 | −258.4 | 92.4 | 1.25 | 1.24 | c | 997 |
| [FIG. 4F] | | | | | | | | |
| Fe₂CoB₂ | P4̅m2 (115) | 4 | −257.8 | 92.9 | 1.22 | 1.48 | c | 870 |
| [FIG. 4G] | | | | | | | | |

Crystallographic data, such as lattice constants and atomic coordinates, of these compounds can be found in the Magnetic Materials Database (30). For comparison, experimental data for bcc Fe and hcp Co are given in italics.

To validate and verify the theoretical findings, a nonequilibrium technique involving a rapid quenching of molten alloys was employed to fabricate the new Fe₃CoB₂ compound (see Materials and Methods), which exhibits comparatively lower energy above the convex hull as mentioned in the paragraph above. The experimental X-ray diffraction (XRD) pattern of the Fe₃CoB₂ compound is compared with the simulated XRD pattern of the orthorhombic structure noted in the paragraph above as shown in FIG. 5A. The positions and intensities of the experimental XRD peaks are in good agreement with the calculated ones. The formation of the predicted Fe₃CoB₂ compound with the orthorhombic structure was confirmed.

FIG. 5B shows the field-dependent magnetization measured at 10 K, which indicates a high Jₛ for the new compound as predicted by theory, along with a coercivity of H_{c}=0.22 kOe (FIG. 5B, Inset). The results also indicate that the Curie temperature T_{c} is higher than room temperature. The law-of-approach-to-saturation method was used to determine the magnetic anisotropy constant K₁ and the saturation magnetization Mₛ (34). By following this approach, the magnetization data measured at 10 K and 300 K near saturation (Mₛ) in the field range of 30 to 70 kOe was fit using the equation M=Mₛ (1−A/H²)+xH as shown in the inset of FIG. 5B, where x is the high-field susceptibility and the constant A depends on K₁ as given by

$$A = \frac{4}{15} \frac{{K}_{1}^{2}}{{M}_{s}^{2}} \cdot$$

This analysis yields K₁=1.0 MJ/m³ and Jₛ=1.35 T at 300 K and K₁=1.2 MJ/m³ and Jₛ=1.39 T at 10 K, which are in excellent agreement with the calculated values of K₁=1.34 MJ/m³ and Jₛ=1.40 T, respectively.

These results demonstrate that the theoretical guidance by a machine learning-assisted material search and density functional theory calculations are important in accelerating materials discovery. This approach quickly identifies magnetic compounds with desired magnetic properties and avoids a time-consuming and expensive experimental optimization process. The room-temperature magnetic properties of Fe₃CoB₂ (K₁=1.0 MJ/m³ and Jₛ=1.35 T) yield an anisotropy field of Hₐ=2K₁/Mₛ=1.86 T. For potential permanent-magnet materials, Hirayama et al. have proposed that the anisotropy field (Bₐ=μ₀Hₐ) must be larger than 1.35 Jₛ by considering intrinsic Bₐ and nanostructural details (35). Such materials may exhibit energy products as high as J²ₛ/4, if appropriate nanostructuring and alignment of grains are achieved. Fe₃CoB₂ fulfills the above-mentioned criteria for the anisotropy field (Bₐ>1.35 Jₛ). Thus, the new compound or its modification can be important for next-generation critical-materials issues in energy systems.

In summary, an effective feedback loop through a combination of machine learning, adaptive genetic algorithm, and first-principles density functional theory calculations was illustrated. The efficient machine learning screening provides fast predictions of promising chemical compositions and crystal structures. The subsequent density functional theory calculations and adaptive genetic algorithm search yield a good estimation for the energetic stability and magnetic properties of candidate structures. This combination enables efficient materials discovery with desirable stability and properties by experiments.

It is noted that the machine learning-guided approach used herein is different from common high-throughput approaches in the literature (9, 13, 15, 36) in two aspects. First, in the approach used herein, the high-throughput screening is done much faster with an efficient machine learning model. Only a small fraction of the structures are checked by first-principles calculations to provide the promising compositions for adaptive genetic algorithm search. Another notable advantage of the approach used herein is that new structures (beyond known structures) are continuously added to the structure pool by the adaptive genetic algorithm search. The feedback from the adaptive genetic algorithm is important since the adaptive genetic algorithm can provide relevant new structures to significantly increase the likelihood for the new materials discovery, especially for ternary and quaternary compounds where available structures from known databases are limited.

Only 2,525 structures (which is less than 0.7% of the total structures screened by machine learning) predicted by machine learning and 1,817 structures by adaptive genetic algorithm are required to be optimized by density functional theory calculations. According to the timing from the calculations here, it is estimated that such calculations can be done within a week on a cluster computer of 200 nodes (24-32 cores per node).

The approach used herein efficiently discovered seven Fe—Co—B ternary compounds suitable for permanent-magnet applications. Among them, the lowest-energy Fe₃CoB₂ structure has been synthesized by experiment. With the guidance from the computational study that pinpointed the promising composition, it took only a few days to successfully synthesize the new Fe₃CoB₂ compound and characterize the structural and magnetic properties. The ML-AGA-DFT experimental framework thus provides timely feedback between computation and experiment to greatly accelerate new materials exploration and discovery.

In this work, B with Fe—Co was selected to demonstrate a “proof of principles” of the proposed machine learning-guided feedback framework. Discovery of rare earth-free magnetic materials with other elements is also possible. More new structures for this system or other systems can be discovered by further adaptive iterations to refine the machine learning model using this framework.

It is also noted that further understanding regarding why Fe₃CoB₂ can have good energetic stability and high magnetization and magnetic anisotropy can also provide useful insights for accelerating the design and discovery of magnetic materials. In general, magnetization comes from transition metal elements (Fe and Co). Therefore, compositions rich in Fe and Co can provide high magnetization. However, the origin of magnetic anisotropy is much more complex. While previous work has endeavored to develop a relationship between composition, crystal structure, and magnetic anisotropy (37, 38), a quantitative theory for making such predictions is lacking. Even with the same composition, the symmetry of the crystalline structure, the arrangement, and the local environment of Fe and Co atoms can have significant impact on the magnetic properties, especially the magnetic anisotropy.

In this study, several Fe₃CoB₂ structures with the same composition and with similar formation energy were discovered through the adaptive genetic algorithm search. Although these structures have similar magnetic polarization Jₛ>1 T, the magnetic anisotropic constant K₁ spreads from 0.06 to 1.40 MJ/m³, and only one structure (the one shown in FIG. 4A and produced by experiment) has K₁ larger than 1 MJ/m³.

### Materials and Methods

Computational Methods. The CGCNN model is built with CNNs on top of a crystal graph consisting of convolutional layers and pooling layers (28). Crystals are converted to crystal graphs with nodes representing atoms in the unit cell and edges representing atom connections. The 1G-CGCNN model is trained using the structures and energies of 28,046 compounds from density functional theory calculations in the Materials Project database (29) following the instructions provided in previous research (28). The nodes of the crystal graph are represented by nine atomic properties of the elements: group number, period number, electronegativity, covalent radius, valence electrons, first ionization energy, electron affinity, block, and atomic volume. The graph edges are characterized by neighboring bonds for each atom/node. R convolutional layers and L1 hidden layers are built on top of these nodes, resulting in a new graph with each node representing the local environment of each atom. After pooling, a vector representing the entire crystal is connected to L2 hidden layers, followed by the output layer to provide the prediction. The mean absolute error of the validation for the 1G-CGCNN model is 0.039 eV/atom. The 1G-CGCNN model is used to perform the screening of the hypothetical structures as described above. Then the 2G-CGCNN model is trained based on the density functional theory formation energies for the structures from 1G screening and from those Fe—Co-based structures from a magnetic materials database (30) as discussed above. The dataset is divided into a training set (80%), validation set (10%), and test set (10%), respectively. 40 epochs of the learning process were performed and the best model was selected as the 2G-CGCNN model, with the lowest mean absolute error of the validation set (0.104 eV/atom) and the test set (0.136 eV/atom).

The density functional theory calculations were performed using VASP package (39-41). The Perdew-Burke-Ernzerhof function (42) combined with the projector-augmented wave method (43) and a cutoff energy of 500 eV are used. A k-point grid with a mesh size of 2π×0.025 Å⁻¹ generated by the Monkhorst-Pack scheme was used. This mesh size is fine enough to sample the first Brillouin zone for achieving better k-point convergence (44). On top of self-consistent spin-polarized calculations, non-self-consistent noncollinear calculations including the spin-orbit coupling effects were carried out for magnetocrystalline anisotropy energy calculations (41). When the spin-orbit couplings are taken into account, symmetry operations are completely turned off and the spin-quantization axis was set to be along different directions. The magnetocrystalline anisotropy energy is calculated by taking the energy differences between different spin orientations, while the direction with lowest energy is referred as the easy axis; K₁ is then obtained by the energy difference between the easy axis and the axis with the second-lowest energy E-E_{easy}. The Curie temperature (T_{c}) is evaluated within mean-field approximation by taking the energy difference between ferromagnetic (FM) and antiferromagnetic (AFM) configurations via the simple formula (45):

$${T}_{c} ∼ 2 \frac{{E}_{AFM} - {E}_{FM}}{3 {k}_{B}}$$

An adaptive genetic algorithm (2, 6, 46) was employed to further search for possible lower-energy structures based on the chemical compositions selected from the machine learning and density functional theory calculations. In addition to the conventional genetic algorithm (GA) loop, the adaptive genetic algorithm adds in an adaptive loop to adaptively adjust the auxiliary interatomic potential used in the conventional genetic algorithm process. The most time-consuming structure relaxation and energy evaluation step in the conventional genetic algorithm loop is done efficiently by using the auxiliary interatomic potential. The adaptive loop adjusts the auxiliary interatomic potential from iteration to iteration guided by the accurate results from density functional theory calculations on the structures selected from the previous interaction of the genetic algorithm search. Only single-point density functional theory calculations on a small subset of candidate structures obtained from the previous genetic algorithm loop (using the auxiliary interatomic potential) are needed at each iteration to guide the adjustment of the potential. The auxiliary interatomic potential for the Fe—Co—B system is expressed according to the embedded atom method (47) with some adjustable parameters. Energies, forces, and stresses of these structures from first-principles density functional theory calculations are used to update the parameters of the auxiliary interatomic potentials by, e.g., the force-matching method with a stochastic simulated annealing algorithm as implemented in the potfit code (48, 49). Another cycle of genetic algorithm search is then performed using the newly adjusted interatomic potential, followed by the readjustment of the potential parameters, and the adaptive genetic algorithm iteration process is then repeated. In this way, for a given composition of the Fe—Co—B ternary, the auxiliary interatomic potential can help in fast sampling of the configuration space through genetic algorithm and expensive density functional theory calculations are kept at the minimal without losing the accuracy of the structure search.

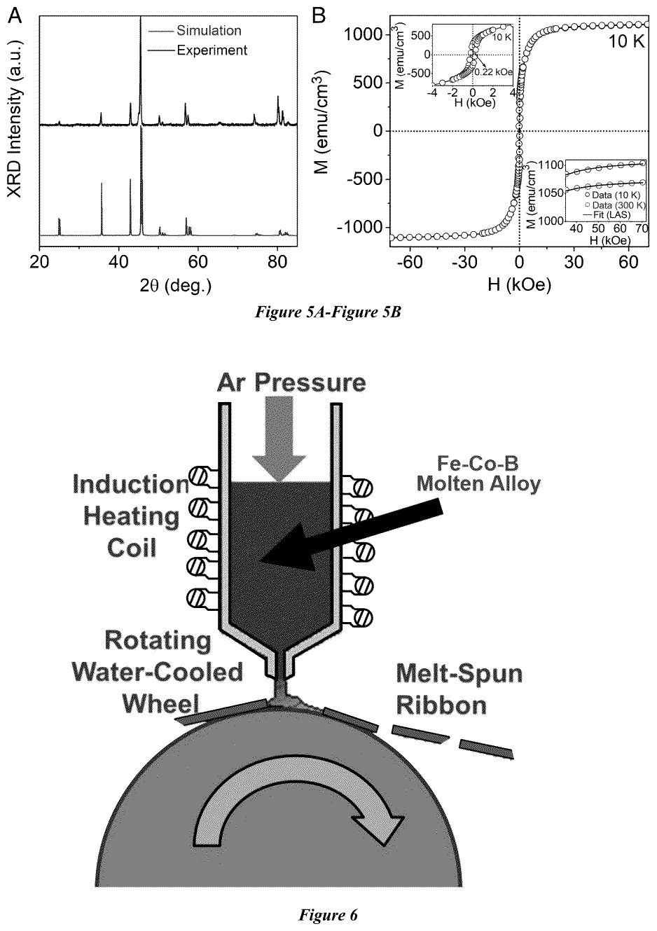

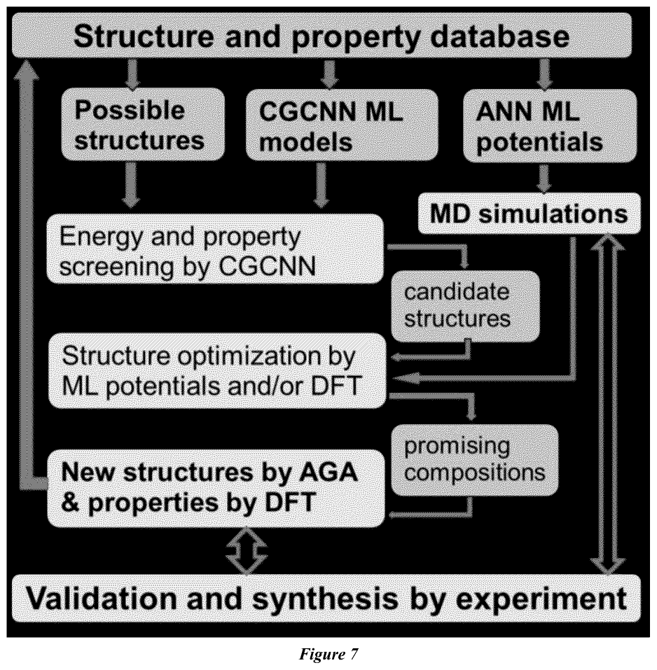

Experimental Methods. To fabricate the Fe₃CoB₂ compound, appropriate amounts of high-purity Fe, Co, and B elements were melted using a conventional arc-melting process to obtain alloys with a Fe₃CoB₂ composition. The arc-melted alloys were remelted to a molten state in a quartz tube and subsequently ejected onto the surface of a water-cooled rotating copper wheel to form nanocrystalline ribbons of approximate width 2 mm and thickness 40 μm. The cooling rate during the melt-spinning process is of the order 10⁶ K/s, which facilitates the stability of the metastable structures without decomposition or transformation into equilibrium/ground-state structures. The melt-spinning equipment used for producing the Fe₃CoB₂ compound is shown in FIG. 6. The speed of the copper wheel was adjusted to 30 m/s to form the Fe₃CoB₂ compound.

The magnetic properties for the Fe₃CoB₂ compound were measured using the superconducting quantum interference device (SQUID) magnetometer from Quantum D.

### REFERENCES

1. D. M. Deaven, K. M. Ho, Molecular geometry optimization with a genetic algorithm. Phys. Rev. Lett. 75, 288-291 (1995).
2. S. Q. Wu et al., An adaptive genetic algorithm for crystal structure prediction. J. Phys. Condens. Matter 26, 035402 (2014).
3. D. E. Goldberg, J. H. Holland, Genetic algorithms and machine learning. Mach. Learn. 3, 95-99 (2021).
4. D. C. Lonie, E. Zurek, XtalOpt: An open-source evolutionary algorithm for crystal structure prediction. Comput. Phys. Commun. 182, 372-387 (2011).
5. B. Balamurugan, B. Das, W. Y. Zhang, R. Skomski, D. J. Sellmyer, Hf—Co and Zr—Co alloys for rare-earth-free permanent magnets. J. Phys. Condens. Matter 26, 064204 (2014).
6. X. Zhao et al., Exploring the structural complexity of intermetallic compounds by an adaptive genetic algorithm. Phys. Rev. Lett. 112, 045502 (2014).
7. B. Balasubramanian et al., Synergistic computational and experimental discovery of novel magnetic materials. Mol. Syst. Des. Eng. 5, 1098-1117 (2020).
8. J. E. Saal, S. Kirklin, M. Aykol, B. Meredig, C. Wolverton, Materials design and discovery with high-throughput density functional theory: The open quantum materials database (OQMD). JOM 65, 1501-1509 (2013).
9. G. R. Schleder, A. C. M. Padilha, C. M. Acosta, M. Costa, A. Fazzio, From DFT to machine learning: Recent approaches to materials science—a review. Journal of Physics: Materials 2, 032001 (2019).
10. W. Chen, “High-throughput computing for accelerated materials discovery” in Computational Materials System Design, D. Shin, J. Saal, Eds. (Springer International Publishing, Cham, Switzerland, 2018), pp. 169-191.
11. L. Himanen, A. Geurts, A. S. Foster, P. Rinke, Data-driven materials science: Status, challenges, and perspectives. Adv. Sci. (Weinh.) 6, 1900808 (2019).
12. S. Curtarolo et al., AFLOW: An automatic framework for high-throughput materials discovery. Comput. Mater. Sci. 58, 218-226 (2012).
13. J. Cai, X. Chu, K. Xu, H. Li, J. Wei, Machine learning-driven new material discovery. Nanoscale Adv. 2, 3115-3130 (2020).
14. J. E. Gubernatis, T. Lookman, Machine learning in materials design and discovery: Examples from the present and suggestions for the future. Phys. Rev. Mater. 2, 120301 (2018).
15. R. Vasudevan, G. Pilania, P. V. Balachandran, Machine learning for materials design and discovery. J. Appl. Phys. 129, 070401 (2021).
16. A. G. Kusne et al., On-the-fly machine-learning for high-throughput experiments: Search for rare earth-free permanent magnets. Sci. Rep. 4, 6367 (2014).
17. A. Kabiraj, M. Kumar, S. Mahapatra, High-throughput discovery of high Curie point two-dimensional ferromagnetic materials. npj Comput. Mater. 6, 35 (2020).
18. D. Torelli, H. Moustafa, K. W. Jacobsen, T. Olsen, High-throughput computational screening for two-dimensional magnetic materials based on experimental databases of three-dimensional compounds. npj Comput. Mater. 6, 158 (2020).
19. H. Zhang, High-throughput design of magnetic materials. Electronic Structure 3, 033001 (2021).
20. G. Katsikas, S. Charalampos, K. Joseph, Machine learning in magnetic materials. Phys. Status Solidi (b) 258, 2000600 (2021).
21. T. D. Rhone et al., Data-driven studies of magnetic two-dimensional materials. Sci. Rep. 10, 15795 (2020).
22. G. A. Landrum, H. Genin, Application of machine-learning methods to solid-state chemistry: Ferromagnetism in transition metal alloys. J. Solid State Chem. 176, 587-593 (2003).
23. I. Miyazato, Y. Tanaka, K. Takahashi, Accelerating the discovery of hidden two-dimensional magnets using machine learning and first principle calculations. J. Phys. Condens. Matter 30, 06LT01 (2018).
24. S. Arapan, P. Nieves, S. Cuesta-L_opez, A high-throughput exploration of magnetic materials by using structure predicting methods. J. Appl. Phys. 123, 083904 (2018).
25. T. Hasegawa, T. Niibori, Y. Takemasa, M. Oikawa, Stabilisation of tetragonal FeCo structure with high magnetic anisotropy by the addition of V and N elements. Sci. Rep. 9, 5248 (2019).
26. X. Zhao et al., Large magnetic anisotropy predicted for rare-earth-free Fe16_xCoxN2 alloys. Phys. Rev. B 94, 224424 (2016).
27. M. Takahashi et al., Magnetic moment of a00-Fe16N2 films (invited). J. Appl. Phys. 76, 6642-6647 (1994).
28. T. Xie, J. C. Grossman, Crystal graph convolutional neural networks for an accurate and interpretable prediction of material properties. Phys. Rev. Lett. 120, 145301 (2018).
29. A. Jain et al., Commentary: The Materials Project: A materials genome approach to accelerating materials innovation. APL Mater. 1, 011002 (2013).
30. M. Sakurai et al., Discovering rare-earth-free magnetic materials through the development of a database. Phys. Rev. Mater. 4, 114408 (2020).
31. P. Avery, E. Zurek, RandSpg: An open-source program for generating atomistic crystal structures with specific spacegroups. Comput. Phys. Commun. 213, 208-216 (2017).
32. G. Pradelli, C. Gianoglio, E. Quadrini, II Sistema Cobalto-Ferro-Boro in Presenza Di Liquido. Metall. Ital.; Ita; Da. 73, 351-362. (1981).
33. D. Fruchart, P. Chaudouet, R. Fruchart, A. Rouault, J. P. Senateur, Etudes structurales de compos_es de type c_ementite: Effet de 1′hydroge0ne sur Fe3C suivi par diffraction neutronique. Spectrom_etrie M€ossbauer sur FeCo2B et Co3B dop_es au57Fe. J. Solid State Chem. 51, 246-252 (1984).
34. G. Hadjipanayis, D. J. Sellmyer, B. Brandt, Rare-earth-rich metallic glasses. I. Magnetic hysteresis. Phys. Rev. B 23, 3349-3354 (1981).
35. Y. Hirayama, T. Miyake, K. Hono, Rare-earth lean hard magnet compound NdFe₁₂N. JOM 67, 1344-1349 (2015).
36. D. Jha et al., Enhancing materials property prediction by leveraging computational and experimental data using deep transfer learning. Nat. Commun. 10, 5316 (2019).
37. Y. Xie, G. A. Tritsaris, O. Grån€as, T. D. Rhone, Data-driven studies of the magnetic anisotropy of two-dimensional magnetic materials. J. Phys. Chem. Lett. 12, 12048-12054 (2021).
38. P. Larson, I. I. Mazin, D. A. Papaconstantopoulos, Calculation of magnetic anisotropy energy in SmCo5. Phys. Rev. B 67, 214405 (2003).
39. G. Kresse, J. Furthm€uller, Efficiency of ab-initio total energy calculations for metals and semiconductors using a plane-wave basis set. Comput. Mater. Sci. 6, 15-50 (1996).
40. G. Kresse, J. Furthm€uller, Efficient iterative schemes for ab initio total-energy calculations using a plane-wave basis set. Phys. Rev. B Condens. Matter 54, 11169-11186 (1996).
41. S. Steiner, S. Khmelevskyi, M. Marsmann, G. Kresse, Calculation of the magnetic anisotropy with projected-augmented-wave methodology and the case study of disordered Fe1-xCox alloys. Phys. Rev. B 93, 224425 (2016).
42. J. P. Perdew, K. Burke, M. Ernzerhof, Generalized gradient approximation made simple. Phys. Rev. Lett. 77, 3865-3868 (1996).
43. P. E. Blöchl, Projector augmented-wave method. Phys. Rev. B Condens. Matter 50, 17953-17979 (1994).
44. M. Sakurai, J. R. Chelikowsky, Real-space pseudopotential method for calculating magnetocrystalline anisotropy. Phys. Rev. Mater. 2, 084411 (2018).
45. P. Kurz, G. Bihlmayer, S. Bl€ugel, Magnetism and electronic structure of hcp Gd and the Gd(0001) surface. J. Phys. Condens. Matter 14, 6353-6371 (2002).
46. X. Zhao et al., Interface structure prediction from first-principles. J. Phys. Chem. C 118, 9524-9530 (2014).
47. M. S. Daw, M. I. Baskes, Semiempirical, quantum mechanical calculation of hydrogen embrittlement in metals. Phys. Rev. Lett. 50, 1285-1288 (1983).
48. P. Brommer, F. Gahler, Effective potentials for quasicrystals from ab-initio data. Philos. Mag. 86, 753-758 (2006).
49. P. Brommer, F. G€ahler, Potfit: Effective potentials from ab initio data. Model. Simul. Mater. Sci. Eng. 15, 295-304 (2007).
50. J. R. Chelikowsky, K.-M. Ho, C.-Z. Wang, D. J. Sellmyer, X. Xu, Fe—Co—B ternary compounds. NovoMag. https://www.novomag.physics.iastate.edu/structure-database. Accessed 19 Oct. 2022.

### Example 2—Accelerating the Discovery and Synthesis of Magnetic Materials

Overview: Described herein are transformative strategies for the design of new magnetic materials. The emphasis herein is on sustainability through earth-abundant and non-critical elements. The work herein couples a strong experimental effort in synthesis and characterization with recent theoretical advances in quantum-modeling algorithms and software, machine learning (ML) and materials informatics, and high-performance hardware.

Magnets play a crucial role in contemporary technologies. They are essential components in generators, computer hard drives, electric motors and other electro-mechanical devices.

Because of their role in such devices, the economy depends largely on the creation of better magnetic materials.

A focus herein is on new bulk and nanoscale magnetic materials. In particular, the discovery of new phases with anisotropic structures, high magnetization, high Curie temperatures, high spin polarization and high magnetic anisotropy, as well as new phases with nanoscale spin-spiral structures are investigated. Materials with these properties will have significant applications in ultra-small spintronics devices, new high-density data-storage schemes and high-energy-product permanent-magnet materials. The design and synthesis of new magnetic materials is a formidable problem, especially given the myriads of possible combinations of composition and structure.

This work represents a different paradigm to accelerate the discovery process.

Computationally driven phase-space explorations are used for composition-structure-property relationships coupled with experiment to identify candidates that have desirable properties. A machine learning-assisted adaptive genetic algorithm coupled to first-principles codes specifically designed for magnetic properties is used for structure and property predictions. The algorithm provides speed and accuracy for fast high-throughput explorations, while maintaining the accuracy of quantum-based calculations.

Experimental research focuses on synthetic techniques and a comprehensive set of characterization methods. Nanoscale to mesoscale crystals can be produced by chemical synthesis and other methodologies with controllable size. Rapid quenching from the melt can produce materials with equilibrium or metastable structures. This experimental/theoretical approach has been successfully applied to predict and synthesize heretofore unknown intermetallic compounds for rare earth-free magnets.

Introduction. Magnetic materials are an essential component in energy generation and conversion devices such as generators, motors and mobile machines, as well as information storage units like computer hard drives. Owing to the role of such devices in advanced technologies and green economies, there is an increasing demand for high performance permanent magnets (PM) (O. Gutfleisch et al. Adv. Mater., 23:821, 2011).

Described herein is a transformative strategy for the discovery, design and synthesis of new “rare-earth-free” materials for magnets. These strategies capitalize on advances in artificial intelligence (AI) and machine learning (ML), database and data science, computational modeling algorithms and software, high performance computing hardware. These advances are coupled with a strong and comprehensive experimental effort.

Most high-performance permanent magnets contain rare earth (RE) elements. While rare earth elements are not “rare,” their unfettered availability is a serious economic and geopolitical issue (The White House Press “FACT SHEET: Securing a Made in America Supply Chain for Critical Minerals,” Feb. 22, 2022. url: https://www.whitehouse.gov/briefing-room/statements-releases/2022/02/22/fact-sheet-securing-a-made-in-America-supplychain-for-critical-minerals).

There is a strategic need to find replacement materials to meet performance and cost goals for advanced electro-magnetic devices. In particular, the design, discovery and synthesis of rare earth-free gap magnets is of considerable interest for the application market as this class of materials represents promising candidates to fill the performance and cost differences between traditional ferrites and rare earth-containing magnets (JMD Coey. Scripta Materialia, 67:524, 2012).

A list of structures (especially those of ternary compounds) available for making useful magnets is far from complete. The number of structures in Pearson's database (P. Villars and K. Cenzual. Pearson's Crystal Data-Crystal Structure Database for Inorganic Compounds. ASM International, Materials Park, Ohio, USA, 2015 (on DVD, release 2015/16)) and other popular databases (e.g., AFLOW (S. Curtarolo et al. comput. mater. sci. 58, 218 (2012). Comput. Mater. Sci., 58:218, 2012; http://aflowlib.org), Materials Project (A. Jain et al. APL Materials, 1(011002), 2013; https://materialsproject.org), the Open Quantum Materials Database (OQMD) (J. E. Saal et al. JOM, 65:1501, 2013; http://ogmd.org), and the NOMAD repository (C. Draxl et al. J. Phys. Mater., 2: 036001, 2019; https://repository.nomad-coe.eu)) is a small fraction of the number of possible structures and compounds. Seemingly, the potential for the discovery of new materials for rare earth-free gap magnets in this realm is profound. Yet, efficient searches for special materials in this myriad of possible combinations of various chemical components and structures is a daunting task.

If materials discovery is to be accelerated, there is a need to efficiently establish accurate relationships among chemical compositions, crystal structures, and physical properties. Over past few decades, several efficient computational algorithms have been developed to predict stable crystal structures based on given chemical compositions, and have made contributions to materials discovery (S. Wu et al. J. Phys. Cond. Matt., 26: 035402, 2014; X. Zhao et al. Phys. Rev. Lett., 112: 045502, 2014; X. Zhao et al. J. Phys. Chem. C, 118: 9524, 2014; A. R. Oganov et al. J. Phys. Cond. Matt., 20: 064210, 2008; A. O. Lyakhov et al. Comp. Phys. Comm., 184: 1172, 2013; Y. Wang et al. Comp. Phys. Commun., 83: 2063, 2012; C. J. Pickard et al. J. Phys. Cond. Matt., 23: 053201, 2011; M. Amsler et al. J. Chem. Phys., 133: 224104, 2010; S. Arapan et al. J. Appl. Phys., 123: 083904, 2018). However, using existing structural search algorithms to examine all possible compositions in this vast space is unrealistic, and the chance to discover desired materials is not great. High-throughput approaches using first-principles calculations for materials discovery have also been developed. These approaches cover a wide range of compositions by exploring compounds through substituting various chemical species into known crystal-structure lattices (S. Curtarolo et al. comput. mater. sci. 58, 218 (2012). Comput. Mater. Sci., 58: 218, 2012; J. E. Saal et al. JOM, 65: 1501, 2013; G. R. Schleder et al. Journal of Physics: Materials, 2: 032001, 2019; W. Chen. High-throughput computing for accelerated materials discovery. In D. Shin and J. Saal, editors, Computational Materials System Design, page 169. Springer International Publishing, 2018; L. Himanen et al. Adv. Sci., 6: 1900808, 2019; H. Zhang. Electronic Structure, 3: 033001, 2021; D. Torelli et al. npj Computational Materials, 6: 158, 2020). Most of the substitutional structures are not energetically favorable. Performing first-principles calculations on these uninteresting structures is often a fruitless activity.

Rapid advances in AI/ML algorithms, information infrastructures and data sciences, as well as computer hardware/software offer great opportunities to develop new, transformative strategies for materials design, discovery, and synthesis (J. E. Gubernatis et al. Phys. Rev. Mater., 129: 070401,2021; R. Vasudevan et al. J. Appl. Phys., 129: 070401, 2021; A. G. Kusne et al. Sci. Rep., 4: 6367, 2014; A. Kabiraj et al. npj Computational Materials, 6:35, 2020; J. Cai et al. Nanoscale Advances, 2:3115, 2020; G. Katsikas et al. phys. stat. sol. (b), 258: 2000600, 2021; T. D. Rhone et al. Sci. Rep., 10: 15795, 2020; G. A. Landrum et al. J. Solid State Chem., 176: 587, 2003; I. Miyazato et al. J. Phys. Cond. Matt., 30: 06LT01, 2018). In particular, machine learning techniques can assist in rapidly screening the vast composition-structure space to select promising candidates for first-principles calculations. Successful applications of machine learning approaches in accelerating materials discovery have been recently demonstrated (T. Xie et al. Phys. Rev. Lett., 120: 145301, 2018; C. W. Park et al. Phys. Rev. Mater., 4: 063801, 2020; W. Xia et al. PNAS, 119: e2204485119, 2022; R. H. Wang et al. npj Computational Materials, 8: 258, 2022; H. J. Sun et al. Inorganic Chem., 61: 16699, 2022). In these cases, the efficiency of machine learning approaches heavily relies on the accuracy of the machine learning model predictions. For example, machine learning models with a poor accuracy can either substantially overestimate the potential number of candidate structures putting an unnecessary burden on the application of subsequent first-principles calculations, or miss promising targets. An optimal approach using an accurate machine learning screening is clearly desirable where a minimal number of promising candidate structures are selected for first-principles calculations. Moreover, an effective use of AI/ML and data science to guide predictive experimental synthesis remains an evident challenge.

The project herein focuses on a class of new bulk and nanoscale rare earth-free magnetic materials. The efficient discovery and synthesis of new phases with high magnetization, high Curie temperatures, high spin polarization and high magnetic anisotropy is targeted. Materials with these properties have important applications in high-energy-product permanent magnet materials, ultra-small spintronics devices, biomedical therapies, and new high-density data-storage schemes. This work effectively integrates AI/ML algorithms and materials databases with state-of-the-art computational methods and high performance computing hardware along with validation by synthesis and characterization. Such an integrated framework offers a new paradigm for accelerating new materials discoveries in the digital era and will be transferable to the discovery of other classes of materials.

Successful searches for rare earth-free magnets require a combination of state-of-the-art computational and experimental approaches. Efficient computational approaches including AI/ML-guided framework (W. Xia et al. PNAS, 119: e2204485119, 2022), the adaptive genetic algorithm (AGA) (S. Wu et al. J. Phys. Cond. Matt., 26: 035402, 2014; X. Zhao et al. Phys. Rev. Lett., 112: 045502, 2014; X. Zhao et al. Interface structure prediction from first-principles. J. Phys. Chem. C, 118: 9524, 2014) and first-principles calculations have been developed and implemented to predict the structures and magnetic properties of new magnetic materials (M. Tiago et al. Phys. Rev. Lett., 97: 147201, 2006).

The computational studies can be closely coupled with a vigorous experimental effort. The computational/experimental feedback loop enables the discovery and synthesis of new materials, including several rare earth-free compounds with high magnetocrystalline anisotropies K₁>10 Mergs/cm³, large saturation magnetic polarizations Jₛ>10 kG, and high Curie temperatures T_{c}>300 K (W. Xia et al. PNAS, 119: e2204485119, 2022; B. Balasubramanian et al. Mol. Syst. Des. Eng., 5: 1098, 2020).

Scientific and technological impact. A successful implementation of this approach can dramatically alter how one designs materials. Current work on discovering new materials is often accomplished using an Edisonian trial and error process based on zero-temperature ground state structures. This work offers a different paradigm to accelerate the discovery process. Computationally driven phase-diagram exploration and materials-structure prediction, and property characterization at zero and finite temperatures are employed. Computational data is coupled with experimental non-equilibrium synthesis to identify and fabricate materials with desirable properties for magnetic applications.

The adaptive genetic algorithm coupled with first-principles codes is currently used for accurate and efficient ground-state structure and property searches. New techniques and computational approaches utilizing machine learning and databases are developed to address structural stability and phase-selection pathways also at finite temperature. Reliable computational tools that can predict material structures from given chemical compositions at finite temperatures and under non-equilibrium synthesis conditions will be beneficial to the development and discovery of materials for magnets. Also, these tools will find wide applications in the emerging new discipline of computational material science for discovery and design.

Results. A focus was on implementing new and successful strategies for the discovery and design of materials for magnets to eliminate or minimize the use of rare earth elements.

Given the broad number of unexplored possibilities (e.g., ternary alloys), research focused on iron- and/or cobalt-rich alloys. These alloys are free from economically vulnerable rare earth metals and from expensive elements such as Pt. Computations used machine learning and an adaptive genetic algorithm coupled to first-principles calculations for structure and property searches, with timely validation from experimental synthesis and characterization.

Results from these studies demonstrated that the integrated collaborative computational/experimental approach is a successful tack in discovering several promising rare earth-free permanent-magnet materials. Some highlights from these studies are illustrated herein include discovery and synthesis of a high anisotropy Fe₃CoB₂ compound guided by machine learning;

Discovery and synthesis of a high anisotropy Fe₃CoB₂ compound guided by machine learning (W. Xia et al. PNAS, 119: e2204485119, 2022). By combining a crystal graph convolutional neural network (CGCNN) machine learning method with an adaptive genetic algorithm search and first-principles calculations, ˜600 Fe—Co—B ternary compounds were found with Jₛ larger than 10 kG and formation energy within 0.1 eV/atom above convex hull. Among them, seven compounds, including Fe₃CoB₂ as shown in FIG. 4A, are predicted to have K₁ larger than 10 Mergs/cm³. Experimental synthesis of the predicted Fe₃CoB₂ compound was successfully carried out. The simulated x-ray diffraction pattern (XRD) of the predicted Fe₃CoB₂ compound show a good agreement with the experimental XRD as shown in FIG. 5A. The measured magnetic properties, as shown in FIG. 5B, give K₁=10 Megs/cm³ and Jₛ=13.5 kG at 300 K and K₁=12 Mergs/cm³ and Jₛ=13.9 kG at 10 K, which are in excellent agreement with the calculated values at 0 K.

ML-guided framework to accelerate the discovery of new ternary rare earth-free compounds. Even if a search is confined to a subset of elements, which have a high potential for permanent magnets based on chemistry and physics knowledge, the search space for these materials remains vast and complex. Adaptive genetic algorithm (S. Wu et al. J. Phys. Cond. Matt., 26: 035402, 2014; X. Zhao et al. Phys. Rev. Lett., 112: 045502, 2014; X. Zhao et al. J. Phys. Chem. C, 118: 9524, 2014) is not practical to investigate all possible compositions. A robust machine learning strategy to guide a selection of promising compositions for detail investigations by adaptive genetic algorithm and first principles calculations is important for accelerating the discovery.

A machine learning-guided framework is used to substantially advance the discovery of new ternary rare earth-free compounds as outlined in FIG. 7. For a given set of designed chemical elements, a structure pool containing large number (over 500,000) of ternary compounds is generated by substituting the designed elements into the lattices of the existing compounds from databases. Rapid screenings over this set of preliminary structures is conducted by a crystal graph convolutional neural network (CGCNN) machine learning model (T. Xie et al. Phys. Rev. Lett., 120: 145301, 2018; W. Xia et al. PNAS, 119: e2204485119, 2022) to search for compositions and crystal structures that would have favorable formation energies and magnetizations. Favorable candidates are then further evaluated by first-principles calculations (or/and by artificial neural network (ANN) machine learning interatomic potentials) to identify the promising compositions for an adaptive genetic algorithm search. All first-principles calculation results on the low-energy structures predicted by machine learning and adaptive genetic algorithm and their properties will then feed backed to the database, which can be used to adaptively refine the CGCNN model and enlarge the structure pool for next iteration of machine learning-guided search. At the same time, the predicted structures can be verified by experimental synthesis.

Within this framework, high throughput screening is accelerated by an efficient CGCNN machine model. Only a small number of the structures are checked with first-principles calculations. The discovery process can be sped up more than one hundred times as compared to the conventional high throughput first-principles calculations (W. Xia et al. PNAS, 119: e2204485119, 2022; R. H. Wang et al. npj Computational Materials, 8: 258, 2022). Another notable advantage of this approach is that machine learning and the adaptive genetic algorithm continuously provide new structures and data to the database. Thus, the accuracy of the CGCNN model and the quality of the structure pool can be adaptively improved to increase the odds for the discovery of new materials. The recent study on Fe—Co—B system based on such an adaptive feedback loop led to the efficient discovery and synthesis of a new magnetic compound: Fe₃CoB₂ (W. Xia et al. PNAS, 119: e2204485119, 2022). More details about the CGCNN and adaptive genetic algorithm techniques are discussed below.

To validate and verify the machine learning and adaptive genetic algorithm predicted new magnetic phases, synthesis of the phases can be carried out via a variety of experimental techniques including chemical solution synthesis, sputtering and arc melting. Among all the available synthesis techniques, chemical solution methods have their clear advantages in quick processing, accurate composition control and low cost, in comparison with many other methods. Usually chemical synthesis consumes and produces small amount of materials (sub-gram level), which fits well the purpose and scope of timely validation for new materials discovery as magnetic characterization normally requires only a small amount of samples. Another advantage is that chemical synthesis is particularly useful for preparing nanoscale crystals in which less defects and impurities will be included. This kind of nanoscale samples are suitable for the intrinsic property determination.

### Computational Techniques

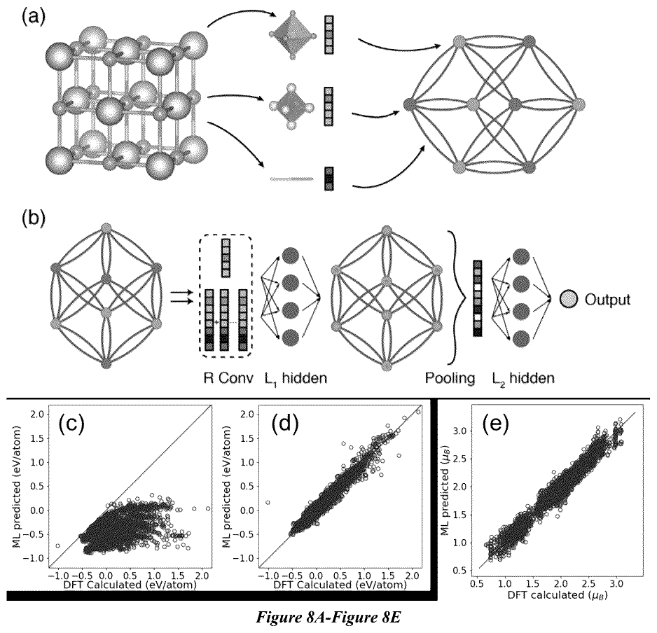

Crystal graph convolutional neural network method. A crystal graph convolutional neural network (CGCNN) approach, developed by Xie and Grossman (T. Xie and J. C. Grossman. Phys. Rev. Lett., 120: 145301, 2018) as shown in FIG. 8A and FIG. 8B, is adopted for predicting compound formation energy and magnetic properties. Within CGCNN, crystal structures are represented by graphs with the nodes of the graph encoding the atomic information of the atoms in the lattice sites of the unit cell and the edges of the graph representing atom connections. R convolutional layers and L1 hidden layers are built on top of these nodes, resulting in a new graph with each node also containing the local environment of each atom. After pooling, a vector representing the entire crystal is connected to L2 hidden layers, followed by the output layer to provide the prediction of the learning property. In this way, the structure-property relationship of the crystals can be learned and predicted from CGCNN.

The original CGCNN model for predicting the formation energy of compounds was trained by Xie and Grossman (T. Xie and J. C. Grossman. Phys. Rev. Lett., 120: 145301, 2018) using 28,046 available structures and DFT-calculated formation energies from the Materials Project (MP) database. This is referred to herein as the XG-CGCNN model. While the XG-CGCNN model can give a correct trend for the formation energy of Fe and Co-based ternary compounds as shown in FIG. 8C, there remains room for improvement of the accuracy of the CGCNN predictions. It was found that more accurate CGCNN model for formation energies of Fe and/or Co based ternary compounds can be trained using the structures and energy data specifically for Fe−Co+X (X=C, B, N, P, Si) ternary compounds from a magnetic materials database as shown in FIG. 8D. CGCNN models were also trained for magnetic properties prediction (T. Liao et al. Phys. Rev. Mater., 6: 024402, 2022). It was shown that CGCNN can accurately predict the structure-magnetization relationship (FIG. 8E, but still have poorer performance in predicting the magnetic anisotropy energy.

In the CGCNN model developed by Xie and Grossman, only bond length information are used to represent the connections of the atoms in the crystal. The CGCMM model can be additionally improved for more accurate prediction of magnetic anisotropy energy by properly incorporating the bond direction information into the crystal graphs. Moreover, as more new data relevant to the categories of materials are obtained from ML+AGA+DFT calculations, the CGCNN models can be adaptively tuned to provide more accurate prediction on the formation energies and magnetic properties.

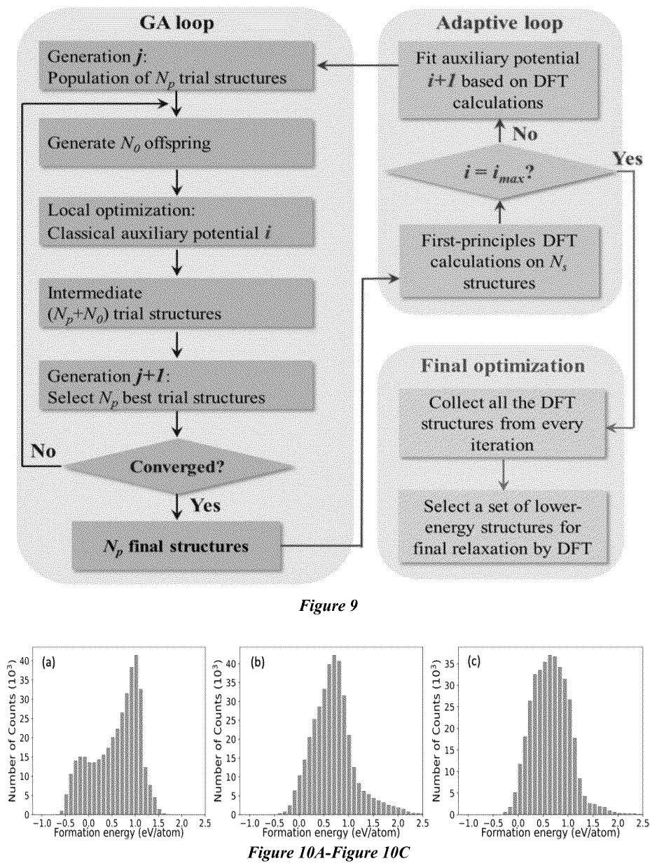

Adaptive genetic algorithm for crystal structure prediction. The adaptive genetic algorithm method for crystal structure prediction is schematically shown in FIG. 9. In addition to the conventional genetic algorithm (GA) loop, which mimics the biological evolution process for structure optimization, the adaptive genetic algorithm adds in an adaptive loop to adaptively adjust the auxiliary interatomic potential used in the conventional genetic algorithm process. The most time-consuming structure relaxation and energy evaluation step in the conventional genetic algorithm loop is done efficiently by using the auxiliary interatomic potential. The adaptive loop adjusts the auxiliary interatomic potential from iteration to iteration guided by the accurate results from DFT calculations on the structures selected from the previous interaction of genetic algorithm search. Only single point DFT calculations on a small subset of candidate structures obtained from the previous genetic algorithm-loop (using the auxiliary interatomic potential) are needed at each iteration to guide the adjustment of the potential. Another cycle of genetic algorithm search is then performed using the newly adjusted interatomic potential, followed by the re-adjustment of the potential parameters, and the adaptive genetic algorithm iteration process is then repeated. In this way, for a given composition, the auxiliary interatomic potential can help in fast sampling of configuration space through genetic algorithm and expensive DFT calculations are kept at the minimal without losing the accuracy of the structure search. Machine learning can be incorporated to further enhance the reliability of the interatomic potentials in the adaptive loop.

### Example 3—Magnetic Iron-Cobalt Silicides Discovered Using Machine-Learning

Abstract. Machine-learning (ML) combined with first principles calculations is employed to discover different rare-earth-free magnetic iron-cobalt silicide compounds. Deep machine-learning models are used to provide rapid screening of over 350 000 hypothetical structures to select a small fraction of promising structures and compositions for further studies by first-principles calculations. An adaptive genetic algorithm is used to search for lower energy structures based on the promising chemical compositions. Such a machine learning-guided approach dramatically accelerates the pace of materials discovery. Four new ternary Fe—Co—Si compounds were discovered, which exhibit desirable properties such as a large magnetic polarization (Jₛ>1.0 T), a significant easy-axis magnetic anisotropy (K₁>1.0 MJ/m³), and a high Curie temperature (T_{c}>840 K). Moreover, the formation energies of these compounds are all within 70 meV/atom relative to the ternary convex hull, offering the possibility of synthesis.

Introduction. Magnetic materials play an important role in advanced technology and clean energy. Specific applications include computer hard drives, cell phones, medical equipment, electric vehicles, and wind turbines. The key properties governing the performance of a magnet include the magnetization, the magnetocrystalline anisotropy, and the Curie temperature. High anisotropy also allows for high coercivity. Although rare-earth elements could lead to high magnetization and anisotropy, such as the case in Nd₂Fe₁₄B₅ and SmCo₅, economic risks call for the search for rare-earth-free alternatives [1-8]. Iron-cobalt based compounds in particular appear promising in this respect [9]. For example, elemental body-centered-cubic Fe and B2-FeCo intermetallics possess sizable ferromagnetic magnetization. However, these compounds are cubic, so no magnetic anisotropy is expected. Anisotropy can be introduced by growing FeCo thin film on substrates, which leads to tetragonal distortion. Alternatively, doping with nonmagnetic elements can stabilize noncubic structures and lead to the enhancement of magnetic anisotropy. Nontoxic dopants for this purpose include Si, N, P, and B. In particular, iron-cobalt silicide is of interest since it is likely to be compatible with a silicon substrate. Magnetic devices, such as storage, using this material may be integrated on silicon technology. The binary phases of Fe—Si and Co—Si subsystems have been previously studied [10-12]. In addition, ternary iron-cobalt silicides of varied levels of crystallinity have been synthesized [13,14]. Most studies on these compounds are focused on characterizing their structural or electric and optical properties. One particular study reported the magnetic properties of two compounds: Fe₂CoSi and FeCo₂Si [15]. They possessed sizable magnetization (magnetic moment per metal atom >1.6_{μB}, where μ_{B} is the Bohr magneton). However, their in-plane anisotropy (anisotropy constant >1.6 MJ/m³) is not suitable for permanent magnet applications. An extensive exploration of the Fe—Co—Si ternary space to identify easy-axis anisotropy candidates is lacking.

Traditional trial and error with experiment can be inefficient in discovering new materials. Alternatively, data-intensive approaches coupled with first-principles calculations is quickly advancing [8,16-34]. Machine learning can assist in rapidly screening a vast composition space [35-38]. The concept of active learning is particularly useful in the context of high throughput first-principles calculations. Active learning seeks to adaptively refine a machine learning model by expanding the training data in the desired property space. By incorporating new calculated data of relevant structures, the model is expected to improve. Success on using such a technique for magnetic materials has been reported for two-dimensional materials [33]. However, the size of the data set was small. A quantitative evaluation of the model improvement is in demand.

A recently proposed machine learning-guided framework is used herein [39]. This framework effectively integrates deep neural network machine learning with first-principles calculations and an adaptive genetic algorithm (AGA). The efficiency of this approach in accelerating materials discovery was previously demonstrated for similar materials, Fe—Co—B. Herein, an extensive search was performed for different magnetic ternary Fe—Co—Si compounds for permanent magnet applications. The improvement over three “generations” (details below) of models is quantified. It is shown that training machine learning on Fe—Co—X data specifically results in an accuracy superior to training on general materials. In addition, feeding back first-principles data of Fe—Co—Si further improves the accuracy. Five new ternary Fe—Co—Si compounds were discovered that exhibit high magnetic polarization (Jₛ>1.0 T), easy-axis magnetic anisotropy (K₁>1.0 MJ/m³), and a high Curie temperature (TC>840 K). The formation energies of these compounds are within 70 meV/atom relative to the ternary convex hull. Compounds this close to the convex hull are likely to be accessible in terms of synthesis.

Methods. In the approach used herein, machine learning models are utilized to provide rapid predictions of chemical compositions and crystal structures, which are likely to be energetically stable and possess desired magnetization. Selected structures from the machine learning screening are further validated by first-principles calculations, and promising compositions from machine learning predictions are further explored using an adaptive genetic algorithm to search for low energy structures. Furthermore, new low-energy structures and their properties obtained from the first-principles calculations and adaptive genetic algorithm search are used to adaptively refine the machine learning model, thus improving the accuracy of the prediction.

The machine-learning model is a crystal graph convolutional neural network (CGCNN) [38]. In CGCNN, the crystal structure is represented by a graph. The nodes and the edges represent the atoms and the bonds, respectively. The atomic descriptors include properties such as the location in the periodic table (group and period), the electronegativity, the covalence radius, the number of valence electrons, the first ionization energy, the electron affinity, and the atomic volume. The bond descriptor is the bond length. Convolutional layers “convolute” the atom feature vectors with their neighboring atoms and bonds. A pooling layer sums the atom feature vectors into one overall feature vector. After a few hidden layers, the prediction is output. The depths mentioned are optimized. In this study, the hyperparameters were mostly set to default values in the code provided in Ref. [38]. Three convolutional layers were used, one pooling layer, and one hidden layer after pooling for the model training. The batch size is set to 256 and the total number of epochs to run is set to 100. Stochastic gradient descent is used as the optimization algorithm. Crystal structures and their properties are the input to the training (and validation and testing) of the model. When a collection of new structures without the corresponding properties are supplied, the machine learning model outputs the predicted properties. After 100 epochs of run, the best model with the minimum mean absolute error of the validation set is selected. The mean absolute error here is used as the criteria of the accuracy of the prediction, which is adaptively improved through an iterative process. The first CGCNN model was directly adopted from Ref. [38], which was trained using the structures and energies of 28 046 compounds in the Materials Project (MP) database from density functional theory (DFT) calculations [38]. This model is referred to herein as the first generation (1G) generalized CGCNN model. In training the models, the data set is divided into training set (80%), validation set (10%), and test set (10%). The mean absolute error of the validation set for the 1G model for formation energy is 0.039 eV/atom. 1G-CGCNN is used to screen hypothetical structures. Then a second generation (2G) CGCNN model is trained using the density functional theory formation energies of 427 Fe—Co—Si structures selected from the prediction of 1G-CGCNN and 3469 Fe—Co—X (X═B, C, N, S) structures from a magnetic materials database [8]. Finally, a third generation (3G) CGCNN model is further trained by adding 1775 Fe—Co—Si structures from 2G-CGCNN prediction and adaptive genetic algorithm structure search (details below).

The trained 2G-CGCNN for formation energy prediction has low mean absolute error for the validation set (0.104 eV/atom) and the test set (0.136 eV/atom). 3G-CGCNN has lower mean absolute error for validation set (0.058 eV/atom) and test set (0.60 eV/atom). It is noted that 1G-CGCNN is more general since it is trained on data involving many different combinations of chemical elements. On the other hand, the 2G and 3G-GCGNN models are specifically trained on Fe—Co—X systems. For magnetic polarization, the same procedure as above was used.

The first-principles calculations are based on density functional theory [40]. The generalized gradient approximation of Perdew, Burke, and Ernzerhof (PBE) [41] was adopted for the exchange-correlation energy functional. The projector-augmented wave (PAW) method was selected [42]. The Monkhorst-Pack scheme [43] is utilized to generate a k-point grid with a mesh size of 2π×0.025 Å⁻¹ for spin-polarized calculations [44]. A cutoff energy of at least 500 eV is used for the wave functions. These settings are used to compute the formation energy and magnetization of structures from machine learning and adaptive genetic algorithm [45].

An adaptive genetic algorithm was employed to search for low energy structures for a given chemical composition [46,47]. For each composition, up to four formula units per unit cell are generated with initial 128 randomized structures. The adaptive genetic algorithm adds an additional loop on the traditional genetic algorithm loop to adaptively adjust the interatomic potential. The most time-consuming step of structural optimization and energy evaluation is accelerated by using an auxiliary interatomic potential based on the embedded atom method [48]. One-shot density functional theory calculations are performed at the end of each genetic algorithm cycle on several of the lowest energy structures. The density functional theory results are used to update the parameters of the potential. Another cycle of genetic algorithm search is then performed using the latest adjusted interatomic potential. This is followed by a readjustment of the potential parameters. The adaptive genetic algorithm iteration process is then repeated. The adaptive genetic algorithm enjoys the efficiency of the traditional genetic algorithm prediction while retaining a high level of accuracy owing to the density functional theory feedback. The formation energy per atom relative to the elemental phases of a Fe_{α}Co_{β}Si_{γ} with α+β+γ=1 is defined as:

$${E}_{f} = E ( {Fe}_{α} {Co}_{β} {Si}_{γ} ) - α E ( Fe ) - β E ( Co ) - γ E ( Si )$$

Here, E(Fe_{α}Co_{β}Si_{γ}) is the total energy per atom of a Fe_{α}Co_{β}Si_{γ} structure. Reference energies are the total energies per atom of body-centered-cubic Fe, hexagonal-close-packed Co, and diamond Si. The energy above the convex hull, Eₕᵤₗₗ, was also calculated by comparing the formation energy of Fe_{α}Co_{β}Si_{γ} with respect to the nearby three known stable phases. The chemical compositions of these phases are located at the vertexes of the Gibbs triangle that encloses the composition of Fe_{α}Co_{β}Si_{γ}. This construction was used to assess the thermodynamic stability against decomposition into the stable phases.

The magnetocrystalline anisotropy energy for the structures with high magnetic polarization (Jₛ>1.0 T) and with formation energies within 0.1 eV/atom above the convex hull were calculated. Spin-polarized calculations were performed for collinear magnetism self-consistently. The spin-orbit couplings were then included and a non-self-consistent calculation was performed [49-51]. When the spin-orbit couplings are included, symmetry operations are removed and the spin-quantization axis is set to the chosen direction. For the magnetocrystalline anisotropy calculations, a finer mesh size of 2π×0.016 Å⁻¹ was used to achieve better accuracy. For the candidate structures, the formation energy and magnetization are updated using these settings.

For each structure, the total energy was calculated for magnetic moments oriented along the Cartesian (100), (010), and (001) directions, respectively. The direction associated with the lowest total energy is labeled as the magnetic “easy” direction. The direction with the second lowest total energy is labeled as the “intermediate” direction. The magnetocrystalline anisotropy constants K₁ is the total-energy difference between the ferromagnetic states with magnetization in the easy and intermediate directions divided by the unit cell volume:

$${K}_{1} = ( {E}_{intermediate} - {E}_{easy} ) / V .$$

A high easy-axis anisotropy is desirable for permanent magnet applications.

Curie temperature T_{C} was calculated using a full potential Korringa-Kohn-Rostocker (KKR) Green function method [52,53]. The nonspherical part of the potential is taken into account in the wave functions exactly. The method has advantages of speed, accuracy, and stability.

The phonon dispersion is calculated using density functional perturbation theory through the PHONOPY code [54,55].

Results and Discussion. First, the 11 916 ternary structures were collected from the Materials Project database which all have an experimental ID in the Inorganic Crystal Structure Database (ICSD) [56]. A structure pool of hypothetical ternary Fe—Co—Si compounds is then generated by threading the three elements Fe, Co, and Si on the lattice of the 11 916 structures. There are six ways to shuffle the three elements on a ternary structure. The volume of the unit cell was allowed to vary by a scaling factor of 0.96-1.04, in increments of 0.02. Since the CGCNN model does not have the interatomic forces to relax the bond lengths in the structures, the use of scaling factor for the volume helps the model differentiate the energetic stability of the same structure with different bond lengths. There are 357 480 ternary Fe—Co—Si structures generated in this way. The 1G-CGCNN model is first used to evaluate the formation energy of these 357 480 structures. The model predicted that there are 832 structures having E_{f}<−0.5 eV/atom. The distribution is shown in FIG. 10A. Out of these, 427 were found to have negative formation energy after density functional theory structural optimization and removing equivalent structures.

The 2G-CGCNN was also applied on the 357 480 hypothetical structures. The formation energy distribution is shown in FIG. 10B. Structures with negative predicted E_{f} are selected for density functional theory optimization, after which 4014 nonequivalent structures are found to have negative E_{f}.

Next, the 3G-CGCNN was applied to a larger hypothetical structure pool. The pool is generated in the same way as described above except we collect all ternary structures from the Materials Project database including those without an experimental ID in ICSD to access more structures. There are 854 070 hypothetical Fe—Co—Si structures in this larger pool. The formation energy histogram from the 3G-CGCNN prediction is shown in FIG. 10C. There are 6185 nonequivalent structures with predicted E_{f}<0 eV. By further applying the machine learning model for magnetization prediction [35], it was found that only 4748 are predicted to have Jₛ>0.5 T. These 4748 structures are optimized by density functional theory calculations, resulting in 1119 nonequivalent structures which cover 270 compositions. The distribution of these 270 compositions and those obtained from density functional theory calculations on the 1G and 2G-CGCNN selected structures are shown in FIG. 11.

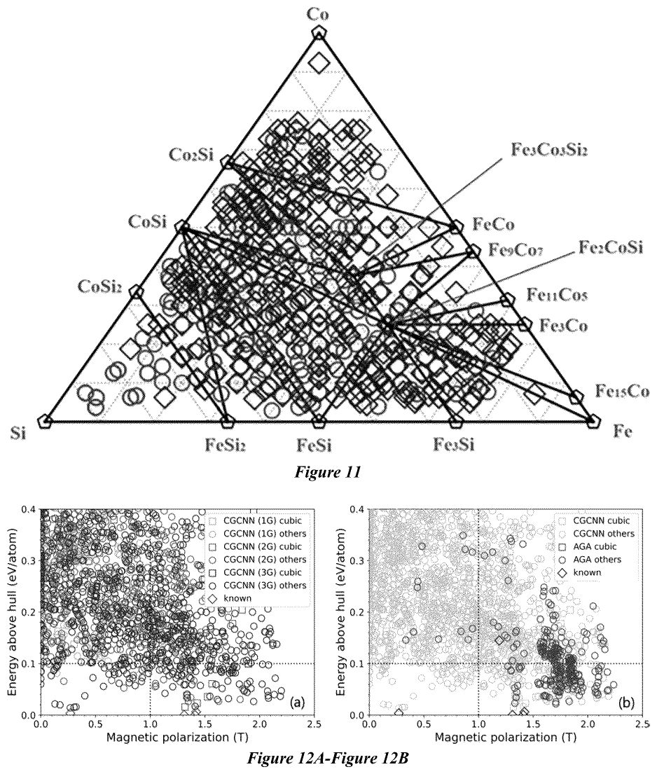

In FIG. 12A, the energetic stability and magnetic polarization from density functional theory calculation for the structures selected by different machine learning generations are displayed. Structures with Eₕᵤₗₗ<0.1 eV/atom and Jₛ>1 T would be promising for magnetic materials. It can be seen that there are no structures from 1G-CGCNN selection in this area. The structures with Eₕᵤₗₗ<0.1 eV/atom and Jₛ>2 T all come from 3G and are noncubic.

From the machine learning screening and density functional theory calculation, eight promising compositions which are transition-metal rich and yield low-energy and high-magnetization structures were discovered. The compositions are Fe—Co—Si=2-1-1, 4-5-1, 12-1-3, 3-4-1, 9-1-2, 9-2-1, 15-4-1, and 6-1-1. These compositions are chosen for further exploration by the adaptive genetic algorithm. 40 adaptive genetic algorithm iterations are performed, with 16 candidate structures selected from each iteration. After 40 adaptive genetic algorithm iterations, 50 structures are selected with the lowest energies calculated by density functional theory. 1000 structures were found from the adaptive genetic algorithm search in total. In FIG. 12B, the formation energy and magnetic polarization for the structures from the adaptive genetic algorithm are compared to those from machine learning. It can be seen that a large proportion of adaptive genetic algorithm structures are within the “target region”: Eₕᵤₗₗ<0.1 eV/atom, Jₛ>1 T, and are noncubic. For Fe—Co—Si compositions of 9-1-2 and 6-1-1, some structures obtained from the adaptive genetic algorithm are energetically more favorable than those obtained by CGCNN screening.

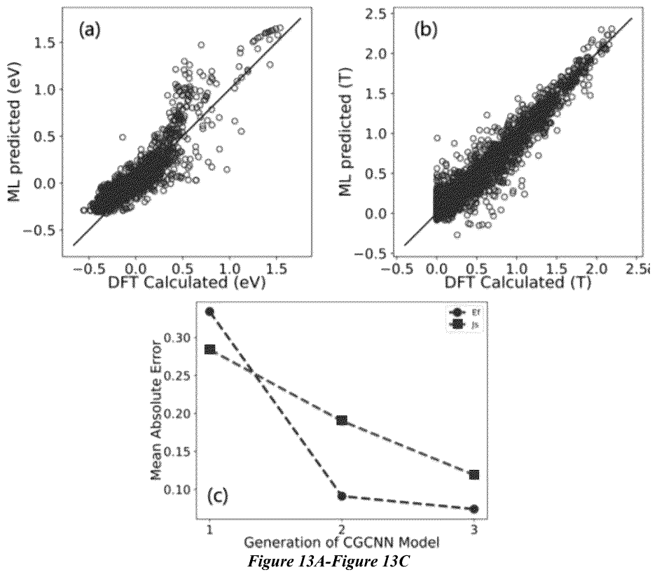

To demonstrate how the iterative process can effectively improve the accuracy of the CGCNN model for the system of interest, the accuracy of different generations of the model were examined on 2281 Fe—Co—Si structures obtained by the CGCNN and adaptive genetic algorithm search. The prediction accuracy of 2G improves upon 1G because 2G is specifically trained on Fe—Co—X structures. Then the model is being further optimized by feeding in more Fe—Co—Si to the 3G-CGCNN training. In FIG. 13A and FIG. 13B, it can be seen that E_{f} and Jₛ of the Fe—Co—Si structures predicted by the 3G model are in good agreement with those from density functional theory calculations. The mean absolute error for predicting E_{f} evolves from 0.334 eV/atom for 1G, 0.091 eV/atom for 2G, to 0.082 eV/atom for 3G as shown in FIG. 13C. Similarly, 0.284, 0.190, 0.119 T were found for 1G, 2G, 3G for the Jₛ prediction. The improvement of E_{f} prediction from 1G to 2G is especially significant compared to that from 2G to 3G. The Jₛ prediction improves at a roughly constant rate over the generations.

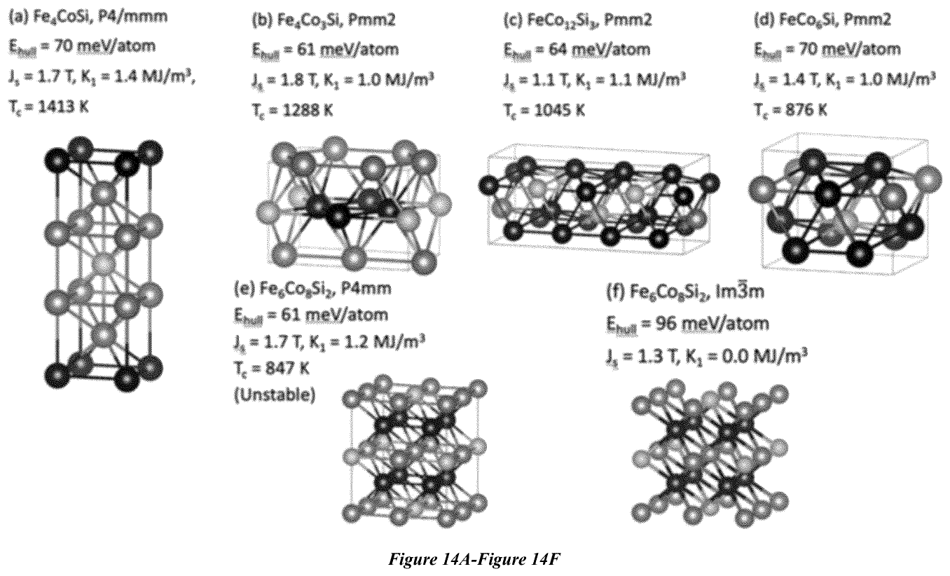

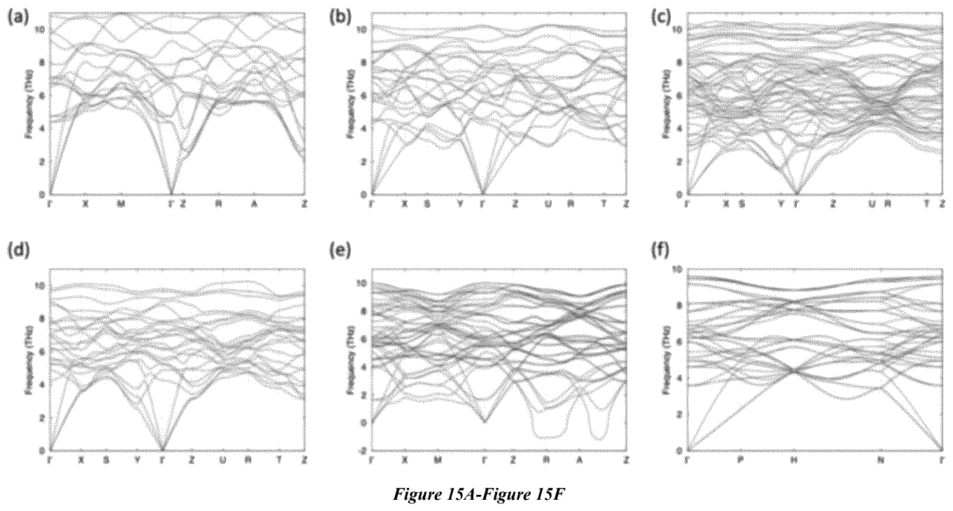

According to FIG. 12B, 114 structures were obtained from the CGCNN+DFT+AGA approach with Eₕᵤₗₗ<0.1 eV/atom and Jₛ>1 T. The magnetic anisotropy constant K₁ and Curie temperature T_{C} for these 114 structures were evaluated using density functional theory calculations. Five structures were found with K₁≥1 MJ/m³ and T_{C} higher than 840 K (FIG. 14A-FIG. 14E). Their formation energies are within 70 meV/atom above the convex hull. Phonon calculations were carried out for the five structures shown in FIG. 14A-FIG. 14E. Four of these structures [FIG. 14A-FIG. 14D] are found to be dynamically stable. The Fe₆Co₈Si₂ structures shown in FIG. 14E exhibits some imaginary modes. An attempt to stabilize this structure was made by moving the atoms in the direction of the eigenvector of the soft phonon mode near R then relaxing the structure. A dynamically stable structure with lower energy was arrived at, as shown in FIG. 14F. However, this lower-energy and dynamically stable structure is a cubic structure and has no magnetic anisotropy. The phonon dispersion are presented in FIG. 15A-FIG. 15F. One candidate structure in FIG. 14A resembles a stacking of body-centered cells. The other three candidate structures in FIG. 14B-FIG. 14D are in the Pmm2 space group. Among these, Fe₄CoSi with space group P4/mmm has large Jₛ=1.7 T, K₁=1.4 MJ/m³, and the highest T_{C}=1413 K.

Finally, it was confirmed that a ferromagnetic (FM) configuration is indeed the ground state for the candidates. A number of antiferromagnetic (AFM) configurations of the four final candidates were tested. Configurations in which the spins of each metal layer point in the same direction were checked. Interlayer directions point oppositely. For the top candidate, Fe₄CoSi, 27 antiferromagnetic configurations were also extensively examined, including 1×2×1 supercells. The ferromagnetic configuration is found to be lower in energy than all of the antiferromagnetic configurations by at least 43 meV/atom. These results confirm that the four candidates are promising for permanent magnet applications. In magnetic materials studies, the stability comparison of ferromagnetic/antiferromagnetic is important. Machine learning models to study ferromagnetic/antiferromagnetic competitions would be interesting but also more challenging (see, for example, Ref. [33]). However, since the scope of this paper is to find stable ferromagnetic structures for rare-earth-free permanent magnets, machine learning models trained for ferromagnetic structure predictions are a more efficient approach. As long as the predicted ferromagnetic structures (usually small numbers for a given ternary) are checked to be energetically favorable than the competing antiferromagnetic states by ab initio calculations, “false positive” ferromagnetic predictions can be avoided. Those structures which have an antiferromagnetic ground state would likely be eliminated by such machine learning screenings, but these structures are not suitable for permanent magnets.

Summary Iron-cobalt silicides are promising rare-earth-free magnet candidates since they may be integrated with silicon technology. A machine-learning guided framework with first principles calculations was utilized to discover such ternary compounds. Three generations of CGCNN machine learning models screened more than 350 000 theoretical structures. An adaptive genetic algorithm was useful for access to new low energy structures based on the promising compositions selected by machine learning. It was demonstrated that the accuracy of the machine learning models can be improved adaptively by incorporating additional Fe—Co—Si structures obtained from the machine learning and adaptive genetic algorithm search in the training data set. Four easy-axis anisotropy candidates were discovered. In particular, the easy-axis Fe₄CoSi compound possessed Jₛ=1.7 T, K₁=1.4 MJ/m³, T_{C}=1413 K.

### REFERENCES

[1]J. M. D. Coey and H. Sun, Improved magnetic properties by treatment of iron-based rare earth intermetallic compounds in anmonia, J. Magn. Magn. Mater. 87, L251 (1990).
[2]J. F. Herbst, R₂Fe₁₄B materials: Intrinsic properties and technological aspects, Rev. Mod. Phys. 63, 819 (1991).
[3]J. M. D. Coey, Magnetism and Magnetic Materials (Cambridge University Press, Cambridge, UK, 2010).
[4]T. Miyake, K. Terakura, Y. Harashima, H. Kino, and S. Ishibashi, First-principles study of magnetocrystalline anisotropy and magnetization in NdFe₁₂, NdFe₁₁Ti, and NdFe₁₁TiN., J. Phys. Soc. Jpn. 83, 043702 (2014).
[5]T. Miyake and H. Akai, Quantum theory of rare-earth magnets, J. Phys. Soc. Jpn. 87, 041009 (2018).
[6]J. Cui, M. Kramer, L. Zhou, F. Liu, A. Gabay, G. Hadjipanayis, B. Balasubramanian, and D. Sellmyer, Current progress and future challenges in rare-earth-free permanent magnets, Acta Mater. 158, 118 (2018).
[7]B. Balasubramanian, M. Sakurai, C.-Z. Wang, X. Xu, K.-M. Ho, J. R. Chelikowsky, and D. J. Sellmyer, Synergistic computational and experimental discovery of novel magnetic materials, Mol. Syst. Des. Eng. 5, 1098 (2020).
[8]M. Sakurai, R. Wang, T. Liao, C. Zhang, H. Sun, Y. Sun, H. Wang, Xin Zhao, S. Wang, B. Balasubramanian, X. Xu, D. J. Sellmyer, V. Antropov, J. Zhang, C.-Z. Wang, K.-M. Ho, and J. R. Chelikowsky, Discovering rare-earth-free magnetic materials through the development of a database, Phys. Rev. Mater. 4, 114408 (2020).
[9]A. A. G. Kusne, T. Gao, A. Mehta, L. Ke, M. C. Nguyen, K.-M. Ho, V. Antropov, C.-Z. Wang, M. J. Kramer, C. Long, and I. Takeuchi, On-the-fly machine-learning for high-throughput experiments: Search for rare-earth-free permanent magnets, Sci. Rep. 4, 6367 (2014).
[10]B. Balasubramanian, P. Manchanda, R. Skomski, P. Mukherjee, S. R. Valloppilly, B. Das, G. C. Hadjipanayis, and D. J. Sellmyer, High-coercivity magnetism in nanostructures with strong easy-plane anisotropy, Appl. Phys. Lett. 108, 152406 (2016).
[11]X. Zhao, S. Yu, S. Wu, M. C. Nguyen, C.-Z. Wang, and K.-M. Ho, Structures, phase transitions, and magnetic properties of Co3Si from first-principles calculations, Phys. Rev. B 96, 024422 (2017).
[12]Z. Yang, S. Wu, X. Zhao, M. C. Nguyen, S. Yu, T. Wen, L. Tang, F. Li, K.-M. Ho, and C.-Z. Wang, Structures and magnetic properties of iron silicide from adaptive genetic algorithm and first-principles calculations, J. Appl. Phys. 124, 073901 (2018).
[13]G. A. Landrum, R. Hoffmann, J. Evers, and H. Boysen, The TiNiSi family of compounds: Structure and Bonding, Inorg. Chem. 37, 5754 (1998).
[14]G. V. Raynor and V. G. Rivlin, 18: Critical evaluation of constitution of cobalt-iron-silicon and iron-nickel-silicon alloys, Int. Met. Rev. 30, 181 (1985).
[15]D. Berling, P. Bertoncini, M. C. Hanf, A. Mehdaoui, C. Pirri, P. Wetzel, G. Gewinner, and B. Loegel, Magnetic properties in epitaxial binary iron and ternary iron-cobalt silicide thin films grown on Si (111), J. Magn. Magn. Mater. 212, 323 (2000).
[16]J. E. Saal, S. Kirklin, M. Aykol, B. Meredig, and C. Wolverton, Materials design and discovery with high-throughput density functional theory: The open quantum materials database (OQMD), JOM 65, 1501 (2013).
[17]G. R. Schleder et al. From DFT to machine learning: Recent approaches to materials science—A review, J. Phys.: Mater. 2, 032001 (2019).
[18]L. Himanen, A. Geurts, A. S. Foster, and P. Rinke, Data-driven materials science: Status, challenges, and perspectives, Adv. Sci. 6, 1900808 (2019).
[19]S. Curtarolo, W. Setyawan, G. L. W. Hart, M. Jahnatek, R. V. Chepulskii, R. H. Taylor, S. Wang, J. Xue, K. Yang, O. Levy et al., AFLOW: An automatic framework for high-throughput materials discovery, Comput. Mater. Sci. 58, 218 (2012).
[20]J. Cai, X. Chu, K. Xu, H. Li, and J. Wei, Machine learning-driven new material discovery, Nanoscale Adv. 2, 3115 (2020).
[21]K. T. Butler, D. W. Davies, H. Cartwright, O. Isayev, and A. Walsh, Machine learning for molecular and materials science, Nature (London) 559, 547 (2018).
[22]J. E. Gubernatis and T. Lookman, Machine learning in materials design and discovery: Examples from the present and suggestions for the future, Phys. Rev. Mater. 2, 120301 (2018).
[23]R. Vasudevan, G. Pilania, and P. V. Balachandran, Machine learning for materials design and discovery, J. Appl. Phys. 129, 070401 (2021).
[24]A. Jain, S. P. Ong, G. Hautier, W. Chen, W. D. Richards, S. Dacek, S. Cholia, D. Gunter, D. Skinner, G. Ceder, and K. A. Persson, Commentary: The materials project: A materials genome approach to accelerating materials innovation, APL Mater. 1, 011002 (2013).
[25]C. Draxl and M. Scheffler, The NOMAD laboratory: From data sharing to artificial intelligence, J. Phys. Mater. 2, 036001 (2019).
[26]S. Sanvito, C. Oses, J. Xue, A. Tiwari, M. Zic, T. Archer, P. Tozman, M. Venkatesan, M. Coey, and S. Curtarolo, Accelerated discovery of new magnets in the Heusler alloy family, Sci. Adv. 3, e1602241 (2017).
[27]P. Nieves, S. Arapan, J. Maudes, R. Marticorena, N. L. Del Brío, A. Kovacs, C. Echevarria-Bonet, D. Salazar, J. Weischenberg, H. Zhang et al., Database of novel magnetic materials for high-performance permanent magnet development, Comput. Mater. Sci. 168, 188 (2019).
[28]A. Kabiraj, M. Kumar, and S. Mahapatra, High-throughput discovery of high Curie point two-dimensional ferromagnetic materials, npj Comput. Mater. 6, 35 (2020).
[29]D. Torelli, H. Moustafa, K. W. Jacobsen, and T. Olsen, High-throughput computational screening for two-dimensional magnetic materials based on experimental databases of three-dimensional compounds, npj Comput. Mater. 6, 158 (2020).
[30]H. Zhang, High-throughput design of magnetic materials, Electron. Struct. 3, 033001 (2021).
[31]G. A. Landrum and H. Genin, Application of machine-learning methods to solid-state chemistry: Ferromagnetism in transition metal alloys, J. Solid State Chem. 176, 587 (2003).
[32]I. Miyazato, Y. Tanaka, and K. Takahashi, Accelerating the discovery of hidden two-dimensional magnets using machine learning and first principle calculations, J. Phys.: Condens. Matter 30, 06LT01 (2018).
[33]T. D. Rhone, W. Chen, S. Desai, S. B. Torrisi, D. T. Larson, A. Yacoby, and E. Kaxiras, Data-driven studies of magnetic two-dimensional materials, Sci. Rep. 10, 15795 (2020).
[34]Y. Xie, G. A. Tritsaris, O. Granas, and T. D. Rhone, Data-driven studies of themagnetic anisotropy of two-dimensional magnetic materials, J. Phys. Chem. Lett. 12, 12048 (2021).
[35]T. Liao,W. Xia, M. Sakurai, R.Wang, C. Zhang, H. Sun, K.-M. Ho, C.-Z. Wang, and J. R. Chelikowsky, Predicting magnetic anisotropy energies using site-specific spin-orbit coupling energies and machine learning: Application to iron-cobalt nitrides, Phys. Rev. Mater. 6, 024402 (2022).
[36]J. Nelson and S. Sanvito, Predicting the Curie temperature of ferromagnets using machine learning, Phys. Rev. Mater. 3, 104405 (2019).
[37]A. Dutta and P. Sen, Machine learning assisted hierarchical filtering: A strategy for designing magnets with large moment and anisotropy energy, J. Mater. Chem. C 10, 3404 (2022).
[38]T. Xie and J. C. Grossman, Crystal Graph Convolutional Neural Networks for an Accurate and Interpretable Prediction of Material Properties, Phys. Rev. Lett. 120, 145301 (2018).
[39]W. Xia, M. Sakurai, B. Balasubramanian, T. Liao, R. Wang, C. Zhang, H. Sun, K.-M. Ho, J. R. Chelikowsky, D. J. Sellmyer, and C.-Z. Wang, Accelerating the discovery of novel magnetic materials using machine learning-guided adaptive feedback, Proc. Natl. Acad. Sci. USA 119, e2204485119 (2022).
[40]W. Kohn and L. J. Sham, Self-consistent equations including exchange and correlation effects, Phys. Rev. 140, A1133 (1965).
[41]J. P. Perdew, K. Burke, and M. Ernzerhof, Generalized Gradient Approximation Made Simple, Phys. Rev. Lett. 77, 3865 (1996).
[42]P. E. Bl6chl, Projector augmented-wave method, Phys. Rev. B 50, 17953 (1994).
[43]H. J. Monkhorst and J. D. Pack, Special points for Brillouin-zone integrations, Phys. Rev. B 13, 5188 (1976).
[44]M. Sakurai and J. R. Chelikowsky, Real-space pseudopotential method for calculating magnetocrystalline anisotropy, Phys. Rev. Mater. 2, 084411 (2018).
[45]P. Giannozzi, S. Baroni, N. Bonini, M. Calandra, R. Car, C. Cavazzoni, D. Ceresoli, G. L. Chiarotti, M. Cococcioni, I. Dabo et al., QUANTUM ESPRESSO: A modular and open-source software project for quantum simulations of materials, J. Phys.: Condens. Matter 21, 395502 (2009).
[46]S. Q. Wu, M. Ji, C.-Z. Wang, M. C. Nguyen, X. Zhao, K. Umemoto, R. M. Wentzcovitch, and K.-M. Ho, An adaptive genetic algorithm for crystal structure prediction, J. Phys.: Condens. Matter 26, 035402 (2013).
[47]X. Zhao, M. C. Nguyen, W. Y. Zhang, C. Z. Wang, M. J. Kramer, D. J. Sellmyer, X. Z. Li, F. Zhang, L. Q. Ke, V. P. Antropov, and K. M. Ho, Exploring the Structural Complexity of Intermetallic Compounds by an Adaptive Genetic Algorithm, Phys. Rev. Lett. 112, 045502 (2014).
[48]M. S. Daw and M. I. Baskes, Semiempirical, Quantum Mechanical Calculation of Hydrogen Embrittlement in Metals, Phys. Rev. Lett. 50, 1285 (1983).
[49]G. Kresse and J. Furthmüller, Efficient iterative schemes for ab initio total-energy calculations using a plane-wave basis set, Phys. Rev. B 54, 11169 (1996).
[50]G. Kresse and J. Furthmüller, Efficiency of ab-initio total energy calculations for metals and semiconductors using a plane-wave basis set, Comput. Mater. Sci. 6, 15 (1996).
[51]S. Steiner, S. Khmelevskyi, M. Marsmann, and G. Kresse, Calculation of the magnetic anisotropy with projected-augmented-wave methodology and the case study of disordered Fe₁₋ₓCoₓ alloys, Phys. Rev. B 93, 224425 (2016).
[52]H. Akai and P. H. Dederichs, A simple improved iteration scheme for electronic structure calculations, J. Phys. C: Solid State Phys. 18, 2455 (1985).
[53]M. Ogura and H. Akai, The full potential Korringa-Kohn-Rostoker method and its application in electric field gradient calculations, J. Phys.: Condens. Matter 17, 5741 (2005).
[54]A. Togo and I. Tanaka, First principles phonon calculations in materials science, Scr. Mater. 108, 1 (2015).
[55]A. Togo, First-principles phonon calculations with phonopy and phono3py, J. Phys. Soc. Jpn. 92, 012001 (2023).
[56]I. Levin, NIST Inorganic Crystal Structure Database (ICSD), 2018.

### Example 4—Machine Learning Assisted Search for Fe—Co—C Ternary Compounds with High Magnetic Anisotropy

The intrinsic magnetic properties of a compound that are critical for high performance permanent magnet applications are the magnetization Jₛ, the magnetocrystalline anisotropy constant K₁, and the Curie temperature T_{C}. Fe-based magnetic materials are attractive, owing to the abundance of Fe and its large atomic magnetic moment and high Curie temperature. Fe—Co binary alloys are good candidates for rare-earth free (RE-free) ferromagnetic materials, but most of them are in cubic structures so no magnetic anisotropy is expected. Combining Fe and Co with a third light element can be a promising approach to obtain stable non-cubic ternary magnetic compounds with high magnetocrystalline anisotropy. In addition to Fe—Co—B and Fe—Co—Si ternary compounds reported previously (W. Xia et al. Proc. Natl. Acad. Sci. U.S.A 119 (47) e2204485119 (2022); Timothy Liao et al. Phys. Rev. Materials 7, 034410 (2023)), in this work, Fe—Co—C ternary compounds for permanent magnets applications are investigated.

The search for the promising Fe—Co—C magnetic compounds is challenging because the number of possible combinations of composition ratio among the three elements and the potential crystal structure they may take is enormous. It is impossible to search for low-energy structures for all these combinations by experiment or currently available crystal structure prediction methods such as genetic algorithm (GA) or particle swarm optimization (PSO). Straightforward high-throughput first-principles calculations for all the possibilities are also not feasible due to the heavy computational cost.

Recent advances in AI/ML algorithms and information infrastructures offer an opportunity to develop new transformative strategies for accelerating materials design and discovery. In this study, the recently developed machine learning-guided framework for materials discovery is adopted (W. Xia et al. Proc. Natl. Acad. Sci. U.S.A 119 (47) e2204485119 (2022); Timothy Liao et al. Phys. Rev. Materials 7, 034410 (2023)), which enables the vast composition-structure space to be efficiently explored to select a small number of promising candidates for first-principles calculations. Such a machine learning-guided approach can substantially speed up the pace of novel materials prediction and discovery.

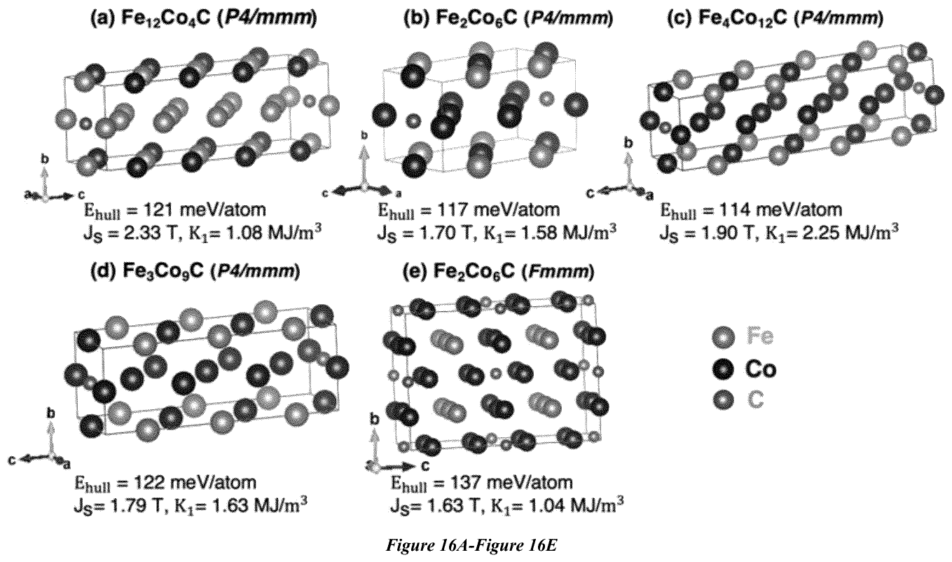

Through the machine learning-assisted screening up to 854,070 possible ternary compounds, which cover a wide range of composition-structure space, 546 structures (0.064%) were identified for further refinement and optimization by first-principles calculations and 7 promising compositions were identified for further exploration by adaptive genetic algorithm (AGA). The machine learning-guided approach effectively lead to the discovery of 5 low-energy metastable Fe—Co—C ternary compounds which exhibit high magnetization polarization (Jₛ≥1.6 Tesla) and high magnetocrystalline anisotropy (K₁≥1.0 MJ/m³) suitable for permanent magnet applications. These structures are shown FIG. 16A-FIG. 16E. Four of these the 5 structures have a tetragonal symmetry and another one has an orthorhombic symmetry. First-principles calculations shown that all these structures have uniaxial magnetic anisotropy with the magnetic easy direction along the c axis.

It is noted that the five promising structures for rare earth-free permanent magnet applications shown in FIG. 16A-FIG. 16E have formation energy Eₕᵤₗₗ about 11-140 meV/atom above the convex hull. With the advances in modern non-equilibrium synthesis methods, these metastable ternary compounds would be synthesizable. As an example, a Fe₂CoC compound with Eₕᵤₗₗ of 156 meV/atom has been previously synthesized (SQ Wu et al. J. Phys. D: Appl. Phys. 50, 215005 (2017)).

### Example 5—Rare-Earth Free Permanent Magnet

The search for new magnetic compounds is important to satisfy an ever-increasing demand for magnets with a wide range of applications including spintronics, data storage, hybrid vehicles, wind and water turbines, home appliances, catalysis, and biomedicine. Specifically, the search for new magnetic materials targets magnets that are free of scarce rare-earth elements and expensive metals such as Pt and exhibit suitable magnetic properties. These properties include a high magnetocrystalline anisotropy (K₁, the energy required to deflect the magnetic moment in a crystal from the easy- to hard-axis direction), a large saturation magnetic polarization (Jₛ=4πMₛ in cgs or μ₀Mₛ in SI, where Mₛ is saturation magnetization above which the magnetization cannot be increased by an applied magnetic field H), a high Curie temperature (T_{c}>300 K, a critical temperature above which a ferromagnetic material transforms to a paramagnet).

The current discovery reports the synthesis of a new rare earth-free magnetic compound, Fe₃CoB₂, through an efficient feedback framework by integrating machine learning (ML), an adaptive genetic algorithm (AGA), first-principles calculations, and experimental synthesis. Magnetic measurements show that Fe₃CoB₂ exhibits a high magnetic anisotropy (K₁=1.2 MJ/m³ at 10 K and K₁=1.0 MJ/m³ at 300 K) and a high saturation magnetic polarization (Jₛ=1.39 T at 10 K and 1.35 T at 300 K), which is suitable for rare earth-free permanent-magnet applications.

High-performance traditional magnetic compounds and alloys contain heavy rare-earth elements including such as Nd or Sm to acquire high K₁, which is essential to develop high coercivity (H_{c}) and energy product (BH)ₘₐₓ in permanent magnets. For high-temperature applications such electrical vehicles, Nd₂Fe₁₄B-based magnets (Neo magnets) must have Dy, which is very rare and comparatively very expensive among the elements used in magnets.

While the saturation magnetic polarization is comparable with Nd₂Fe₁₄B and L10-ordered FePt, the new compound Fe₃CoB₂ also exhibits appreciable K₁ suitable for permanent-magnet applications. The newly discovered compound, Fe₃CoB₂, is free of scarce rare-earth elements and expensive Pt and therefore reduce the cost of magnetic materials used in permanent magnets and recording media, if it is applied.

Discovery of alternative magnets is paramount importance for environmental and energy security for two reasons; (i) the demand for magnets is rapidly growing owing to an increasing world population and modern technological requirements and (ii) the rare-earth elements used in magnets are scarce and mostly situated in one part of the globe. If the new material is explored for practical permanent-magnet applications, it can provide stability for environmental and energy security and mitigate the expected bottlenecks in material supplies in future.

As compared to the traditional permanent magnets used in current technologies, the new compound is free of rare-earth elements and expensive Pt.

Note that (BH)^{max}th=J²ₛ/4 is the maximum theoretical energy product for a magnetic material, and this can be nearly achievable only if the material exhibits a square M-H loop with Mᵣ/Mₛ=1 and H_{c}≥Mᵣ/2, where Mᵣ is the remanent magnetization. The coercivity is an extrinsic property, which is determined by a combination of intrinsic magnetic properties and various nanostructural features. The current inversion only reports the new material Fe₃CoB₂ with intrinsic magnetic properties K₁ and Jₛ. Appropriate nanostructuring of this material can be executed to achieve practically high H_{c} and (BH)ₘₐₓ.

Appreciable K₁ values of Fe₃CoB₂ are promising to improve thermal stability of written bits in high-density recording media. Therefore, the current material can also find applications in data storage.

### Exemplary Aspects

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A magnetic material comprising Fe₄CoSi, Fe₄Co₃Si, FeCo₁₂Si₃, FeCo₆Si, or a combination thereof.

Example 2: The magnetic material of any examples herein, particularly example 1, wherein the magnetic material comprises Fe₄CoSi.

Example 3: A magnetic material comprising Fe₁₂Co₄C, Fe₂Co₆C, Fe₄Co₁₂C, Fe₃Co₉C, Fe₂Co₆C, or a combination thereof.

Example 4: The magnetic material of any examples herein, particularly examples 1-3, wherein the magnetic material exhibits a magnetic anisotropy (K₁) of 1 MJ/m³ or more.

Example 5: The magnetic material of any examples herein, particularly examples 1-4, wherein the magnetic material exhibits a saturation magnetic polarization (Jₛ) of 0.75 Tesla (T) or more or 1 T or more.

Example 6: The magnetic material of any examples herein, particularly examples 1-5, wherein the magnetic material exhibits a Curie temperature of 840 K or more.

Example 7: The magnetic material of any examples herein, particularly examples 1-6, wherein the magnetic material has a formation energy within 100 meV/atom relative to the ternary convex hull.

Example 8: The magnetic material of any examples herein, particularly examples 1-7, wherein the magnetic material exhibits a magnetic anisotropy (K₁) of 1 MJ/m³ or more and a saturation magnetic polarization (Jₛ) of 1 T or more.

Example 9: The magnetic material of any examples herein, particularly examples 1-8, wherein the magnetic material exhibits a magnetic anisotropy (K₁) of 1 MJ/m³ or more and a Curie temperature of 840 K or more.

Example 10: The magnetic material of any examples herein, particularly examples 1-9, wherein the magnetic material exhibits a magnetic anisotropy (K₁) of 1 MJ/m³ or more and the magnetic material has a formation energy within 100 meV/atom relative to the ternary convex hull.

Example 11: The magnetic material of any examples herein, particularly examples 1-10, wherein the magnetic material exhibits a saturation magnetic polarization (Jₛ) of 1 T or more and a Curie temperature of 840 K or more.

Example 12: The magnetic material of any examples herein, particularly examples 1-11, wherein the magnetic material exhibits a saturation magnetic polarization (Jₛ) of 1 T or more and the magnetic material has a formation energy within 100 meV/atom relative to the ternary convex hull.

Example 13: The magnetic material of any examples herein, particularly examples 1-12, wherein the magnetic material exhibits a Curie temperature of 840 K or more and the magnetic material has a formation energy within 100 meV/atom relative to the ternary convex hull.

Example 14: The magnetic material of any examples herein, particularly examples 1-13, wherein the magnetic material exhibits a magnetic anisotropy (K₁) of 1 MJ/m³ or more, a saturation magnetic polarization (Jₛ) of 1 T or more, and a Curie temperature of 840 K or more.

Example 15: The magnetic material of any examples herein, particularly examples 1-14, wherein the magnetic material has a magnetic anisotropy (K₁) of 1 MJ/m³ or more, a saturation magnetic polarization (Jₛ) of 1 T or more, and a formation energy within 100 meV/atom relative to the ternary convex hull.

Example 16: The magnetic material of any examples herein, particularly examples 1-15, wherein the magnetic material has a saturation magnetic polarization (Jₛ) of 1 T or more, a Curie temperature of 840 K or more, and a formation energy within 100 meV/atom relative to the ternary convex hull.

Example 17: The magnetic material of any examples herein, particularly examples 1-16, wherein the magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

Example 18: The magnetic material of any examples herein, particularly examples 1-17, wherein the magnetic material has a high magnetization.

Example 19: The magnetic material of any examples herein, particularly examples 1-18, wherein the magnetic material has a high magnetocrystalline anisotropy energy.

Example 20: The magnetic material of any examples herein, particularly examples 1-19, wherein the magnetic material is substantially free of rare earth elements.

Example 21: The magnetic material of any examples herein, particularly examples 1-20, wherein the magnetic material is dynamically stable.

Example 22: The magnetic material of any examples herein, particularly examples 1-21, wherein the magnetic material has a uniaxial magnetic anisotropy.

Example 23: The magnetic material of any examples herein, particularly examples 1-22, wherein the magnetic material comprises nanoscale to mesoscale crystals.

Example 24: The magnetic material of any examples herein, particularly examples 1-23, wherein the magnetic material is suitable for permanent magnet applications.

Example 25: The magnetic material of any examples herein, particularly examples 1-24, wherein the magnetic material has a ground state ferromagnetic (FM) configuration.

Example 26: A method of making the magnetic material of any examples herein, particularly examples 1-25.

Example 27: The method of any examples herein, particularly example 26, wherein the method comprises a nonequilibrium synthesis method.

Example 28: The method of any examples herein, particularly example 26 or example 27, wherein the method comprises chemical solution synthesis, sputtering, arc melting, or a combination thereof.

Example 29: The method of any examples herein, particularly examples 26-28, wherein the method comprises salt-matrix annealing, surfactant-assisted ball milling, or a combination thereof.

Example 30: The method of any examples herein, particularly examples 26-29, wherein the method comprises high-temperature high-pressure hydro/solvent-thermal synthesis.

Example 31: The method of any examples herein, particularly examples 26-30, wherein the method comprises rapid quenching from a melt to thereby produce a magnetic materials with equilibrium or metastable structures.

Example 32: The method of any examples herein, particularly examples 26-31, wherein the method comprises: combining appropriate amount of high-purity elements to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to rapidly cool the re-melted preliminary alloy to thereby form the magnetic material.

Example 33: A method of making a magnetic material comprising Fe₃CoB₂, the method comprising: combining appropriate amount of high-purity Fe, Co, and B to form a mixture; melting the mixture to form a preliminary alloy; solidifying the preliminary alloy; re-melting the solidified preliminary alloy; and melt-spinning the re-melted preliminary alloy by ejecting the re-melted preliminary alloy onto a surface of a water-cooled rotating wheel to cool the re-melted preliminary alloy at a cooling rate of from 1×10⁴ to 1×10⁸ K/s, from 1×10⁵ to 1×10⁸ K/s, or from 1×10⁴ to 1×10⁶ K/s to thereby form the Fe₃CoB₂ magnetic material; wherein the water-cooled rotating wheel is rotated at a rate of from 20-40 m/s.

Example 34: The method of any examples herein, particularly example 33, wherein rapid quenching from the re-melted preliminary alloy thereby produce the Fe₃CoB₂ magnetic material with equilibrium or metastable structures.

Example 35: The method of any examples herein, particularly example 33 or example 34, wherein the method comprises a nonequilibrium synthesis method.

Example 36: The method of any examples herein, particularly examples 33-35, wherein the magnetic material has an X-ray diffraction pattern comprising characteristic peaks, in terms of plus or minus 0.05 degrees 2θ, at 25.00, 35.52, 42.93, 45.47, 50.22, 51.00, 56.76, 57.43, 74.12, 80.13, and 81.26.

Example 37: The method of any examples herein, particularly examples 33-36, wherein the magnetic material has an X-ray diffraction pattern substantially as shown in FIG. 5A.

Example 38: The method of any examples herein, particularly examples 33-37, wherein the magnetic material exhibits a magnetic anisotropy (K₁) of 1 MJ/m³ or more.

Example 39: The method of any examples herein, particularly examples 33-38, wherein the magnetic material exhibits a saturation magnetic polarization (Jₛ) of 0.75 Tesla (T) or more or 1 T or more.

Example 40: The method of any examples herein, particularly examples 33-39, wherein the magnetic material exhibits a Curie temperature of 840 K or more.

Example 41: The method of any examples herein, particularly examples 33-40, wherein the magnetic material has a formation energy within 100 meV/atom relative to the ternary convex hull.

Example 42: The method of any examples herein, particularly examples 33-41, wherein the magnetic material exhibits a magnetic anisotropy (K₁) of 1 MJ/m³ or more and a saturation magnetic polarization (Jₛ) of 1 T or more.

Example 43: The method of any examples herein, particularly examples 33-42, wherein the magnetic material exhibits a magnetic anisotropy (K₁) of 1 MJ/m³ or more and a Curie temperature of 840 K or more.

Example 44: The method of any examples herein, particularly examples 33-43, wherein the magnetic material exhibits a magnetic anisotropy (K₁) of 1 MJ/m³ or more and the magnetic material has a formation energy within 100 meV/atom relative to the ternary convex hull.

Example 45: The method of any examples herein, particularly examples 33-44, wherein the magnetic material exhibits a saturation magnetic polarization (Jₛ) of 1 T or more and a Curie temperature of 840 K or more.

Example 46: The method of any examples herein, particularly examples 33-45, wherein the magnetic material exhibits a saturation magnetic polarization (Jₛ) of 1 T or more and the magnetic material has a formation energy within 100 meV/atom relative to the ternary convex hull.

Example 47: The method of any examples herein, particularly examples 33-46, wherein the magnetic material exhibits a Curie temperature of 840 K or more and the magnetic material has a formation energy within 100 meV/atom relative to the ternary convex hull.

Example 48: The method of any examples herein, particularly examples 33-47, wherein the magnetic material exhibits a magnetic anisotropy (K₁) of 1 MJ/m³ or more, a saturation magnetic polarization (Jₛ) of 1 T or more, and a Curie temperature of 840 K or more.

Example 49: The method of any examples herein, particularly examples 33-48, wherein the magnetic material has a magnetic anisotropy (K₁) of 1 MJ/m³ or more, a saturation magnetic polarization (Jₛ) of 1 T or more, and a formation energy within 100 meV/atom relative to the ternary convex hull.

Example 50: The method of any examples herein, particularly examples 33-49, wherein the magnetic material has a saturation magnetic polarization (Jₛ) of 1 T or more, a Curie temperature of 840 K or more, and a formation energy within 100 meV/atom relative to the ternary convex hull.

Example 51: The method of any examples herein, particularly examples 33-50, wherein the magnetic material has a magnetic anisotropy (K₁) of 1 MJ/m³ or more, a saturation magnetic polarization (Jₛ) of 1 T or more, a Curie temperature of 840 K or more, and a formation energy within 100 meV/atom relative to the ternary convex hull.

Example 52: The method of any examples herein, particularly examples 33-51, wherein the magnetic material has a high magnetization.

Example 53: The method of any examples herein, particularly examples 33-52, wherein the magnetic material has a high magnetocrystalline anisotropy energy.

Example 54: The method of any examples herein, particularly examples 33-53, wherein the magnetic material is substantially free of rare earth elements.

Example 55: The method of any examples herein, particularly examples 33-54, wherein the magnetic material is dynamically stable.

Example 56: The method of any examples herein, particularly examples 33-55, wherein the magnetic material has a uniaxial magnetic anisotropy.

Example 57: The method of any examples herein, particularly examples 33-56, wherein the magnetic material comprises nanoscale to mesoscale crystals.

Example 58: The method of any examples herein, particularly examples 33-57, wherein the magnetic material is suitable for permanent magnet applications.

Example 59: The method of any examples herein, particularly examples 33-58, wherein the magnetic material has a ground state ferromagnetic (FM) configuration.

Example 60: The magnetic material made by the method of any examples herein, particularly examples 33-59.

Example 61: A method of use of the magnetic material of any examples herein, particularly examples 1-25 or the magnetic material made by the method of any examples herein, particularly examples 33-59.

Example 62: The method of any examples herein, particularly example 61, wherein the method comprises using the magnetic material in an energy generation device, an energy conversion device, an information storage device, an electronic device, an electromechanical device, or a combination thereof.

Example 63: The method of any examples herein, particularly example 61 or example 62, wherein the method comprises using the magnetic material in an energy generation and/or energy conversion device, such as a generator, a motor, a mobile machine, a wind turbine, a water turbine, or a combination thereof.

Example 64: The method of any examples herein, particularly examples 61-63, wherein the method comprises using the magnetic material in an information storage device and/or an electronic device, such as a computer hard drive and/or a cell phone.

Example 65: The method of any examples herein, particularly examples 61-64, wherein the method comprises using the magnetic material in an electromechanical device, such as an electric vehicle and/or a hybrid vehicle.

Example 66: The method of any examples herein, particularly examples 61-65, wherein the method comprises using the magnetic material in medical equipment, spintronics, a home appliance, catalysis, biomedicine, or a combination thereof.

Example 67: The method of any examples herein, particularly examples 61-66, wherein the method comprises using the magnetic material in an ultra-small spintronics device, a high-density data-storage scheme, a high-energy-product permanent-magnet material, or a combination thereof.

Example 68: A device or an article of manufacture comprising the magnetic material of any examples herein, particularly examples 1-25 or the magnetic material made by the method of any examples herein, particularly examples 33-59.

Example 69: The device or an article of manufacture of any examples herein, particularly example 68, wherein the device or an article of manufacture comprises an energy generation device, an energy conversion device, an information storage device, an electronic device, an electromechanical device, or a combination thereof.

Example 70: The device or an article of manufacture of any examples herein, particularly example 68 or example 69, wherein the device or an article of manufacture comprises an energy generation and/or energy conversion device, such as a generator, a motor, a mobile machine, a wind turbine, a water turbine, or a combination thereof.

Example 71: The device or an article of manufacture of any examples herein, particularly examples 68-70, wherein the device or an article of manufacture comprises an information storage device and/or an electronic device, such as a computer hard drive and/or a cell phone.

Example 72: The device or an article of manufacture of any examples herein, particularly examples 68-71, wherein the device or an article of manufacture comprises an electromechanical device, such as an electric vehicle and/or a hybrid vehicle.

Example 73: The device or an article of manufacture of any examples herein, particularly examples 68-72, wherein the device or an article of manufacture comprises medical equipment, spintronics, a home appliance, a catalytic device, a biomedical device, or a combination thereof.

Example 74: The device or an article of manufacture of any examples herein, particularly examples 68-73, wherein the device or an article of manufacture comprises an ultra-small spintronics device, a high-density data-storage scheme, a high-energy-product permanent-magnet material, or a combination thereof.

Other advantages which are obvious and which are inherent to the invention will be evident to one skilled in the art. It will be understood that certain features and sub-combinations are of utility and may be employed without reference to other features and sub-combinations.

This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A magnetic material comprising Fe₄CoSi, Fe₄Co₃Si, FeCo₁₂Si₃, FeCo₆Si, or a combination thereof.

2. The magnetic material of claim 1, wherein the magnetic material comprises Fe₄CoSi.

3. The magnetic material of claim 1, wherein the magnetic material exhibits a magnetic anisotropy (K₁) of 1 MJ/m³ or more, a saturation magnetic polarization (Jₛ) of 0.75 Tesla (T) or more, a Curie temperature of 840 K or more, a formation energy within 100 meV/atom relative to the ternary convex hull, or a combination thereof.

4. The magnetic material of claim 1, wherein the magnetic material is substantially free of rare earth elements.

5. The magnetic material of claim 1, wherein the magnetic material is dynamically stable.

6. The magnetic material of claim 1, wherein the magnetic material has a uniaxial magnetic anisotropy.

7. The magnetic material of claim 1, wherein the magnetic material comprises nanoscale to mesoscale crystals.

8. The magnetic material of claim 1, wherein the magnetic material has a ground state ferromagnetic (FM) configuration.

9. A device or an article of manufacture comprising the magnetic material of claim 1.

10. A magnetic material comprising Fe₁₂Co₄C, Fe₂Co₆C, Fe₄Co₁₂C, Fe₃Co₉C, Fe₂Co₆C, or a combination thereof.

11. The magnetic material of claim 10, wherein the magnetic material exhibits a magnetic anisotropy (K₁) of 1 MJ/m³ or more, a saturation magnetic polarization (Jₛ) of 0.75 Tesla (T) or more, a Curie temperature of 840 K or more, a formation energy within 100 meV/atom relative to the ternary convex hull, or a combination thereof.

12. The magnetic material of claim 10, wherein the magnetic material is substantially free of rare earth elements.

13. The magnetic material of claim 10, wherein the magnetic material is dynamically stable.

14. The magnetic material of claim 10, wherein the magnetic material has a uniaxial magnetic anisotropy.

15. The magnetic material of claim 10, wherein the magnetic material comprises nanoscale to mesoscale crystals.

16. The magnetic material of claim 10, wherein the magnetic material has a ground state ferromagnetic (FM) configuration.

17. A device or an article of manufacture comprising the magnetic material of claim 10.

18. A method of making a magnetic material comprising Fe₃CoB₂, the method comprising:
combining appropriate amount of high-purity Fe, Co, and B to form a mixture;
melting the mixture to form a preliminary alloy;
solidifying the preliminary alloy;
re-melting the solidified preliminary alloy; and
melt-spinning the re-melted preliminary alloy by ejecting the re-melted preliminary alloy onto a surface of a water-cooled rotating wheel to cool the re-melted preliminary alloy at a cooling rate of from 1×10⁴ to 1×10⁸ K/s to thereby form the Fe₃CoB₂ magnetic material;
wherein the water-cooled rotating wheel is rotated at a rate of from 20-40 m/s.

19. A device or an article of manufacture comprising the magnetic material of made by the method of claim 18.
